(19) United States
(12) Patent Application Publication
(10) Pub. No.: US 2026/0205616 A1
(43) Pub. Date: Jul. 16, 2026

(54) METHOD FOR LOW MEMORY ENCODING OF VIDEO

(71) Applicant: KAKADU R & D PTY LTD, Glebe NSW (AU)

(72) Inventors: David Scott Taubman, Pyrmont NSW (AU); Aous Naman, Ropes Crossing NSW (AU)

(21) Appl. No.: 19/135,230

(22) PCT Filed: Dec. 15, 2023
(86) PCT No.: PCT/AU2023/051311

§ 371 Date: Jun. 3, 2025

(30) Foreign Application Priority Data
Dec. 16, 2023 (AU) 2022903882

(51) Int. Cl. H04N 19/426; H04N 19/105; H04N 19/147; H04N 19/154; H04N 19/176

(52) U.S. Cl. CPC H04N 19/426; H04N 19/105; H04N 19/147; H04N 19/154; H04N 19/176

(57) ABSTRACT

Described are methods for video encoding or scalable interactive delivery of a sequence of video frames with non-uniform quality, such that the quality of any given spatial region within a frame generally varies from frame to frame within the sequence. The method is based on the “JPEG2000-based Scalable Interactive Video” (JSIV) framework used where the encoded video frames are comprised of independently encoded elements (code-blocks). The method involves estimating temporal distortion D_{b}^{M}, in a manner that avoids the need for a frame buffer. This disclosure also describes methods that use the D_{b}^{M} value to pre-estimate the quality to which each block should be encoded, so as to limit the complexity of JSIV based video encoding.

### 1 FIELD OF THE INVENTION

This invention relates to video encoding, including scalable interactive delivery of video. More specifically, it relates to the encoding or scalable interactive delivery of a sequence of video frames with non-uniform quality, such that the quality of any given spatial region within a frame generally varies from frame to frame within the sequence.

The methods described in this disclosure are beneficial when the encoded video frames are comprised of independently encoded elements, known here as the “code-blocks,” a primary example being the code-blocks of the JPEG 2000 standard. In fact, the invention may be understood as an enhancement of the “JPEG 2000-based Scalable Interactive Video” (JSIV) framework, published by the inventors more than a decade ago.

### 2 BACKGROUND OF THE INVENTION

JSIV [1] is a flexible framework for disseminating JPEG 2000 encoded video frames over a bandwidth constrained communication channel, which takes advantage of the fact that JPEG 2000 produces a large number of independently encoded elements, known as code-blocks.

In JPEG 2000, each sub-band produced by a discrete wavelet transformation (DWT) of an image is partitioned into blocks and each such block is independently encoded to produce a code-block bit-stream. The embedded block encoding algorithm of JPEG 2000 Part-1 has the property that each code-block bit-stream can be independently truncated at many different points, known as coding passes, providing many opportunities to trade distortion (equivalently, quality) for coded length, on a block-by-block level. This property is used both to directly optimize the encoding of an image or video frame subject to a constraint on the overall encoded size, and to disseminate already encoded images or video frames based on communication bandwidth constraints that apply after the content was originally encoded. In both cases, the optimization strategy that determines how the b^{th} code-block bit-stream should be truncated is known as post-compression rate-distortion optimization (PCRD-opt), which relies upon measurements or estimates of the distortion

$${D}_{b}^{( t )}$$

and the coded length

$${L}_{b}^{( t )}$$

at each potential truncation point t. This

$$( {D}_{b}^{( t )} , {L}_{b}^{( t )} )$$

data constitutes the operational distortion-length (D-L) characteristic for code-block b, as illustrated in FIG. 1, which has been adapted from [2].

FIG. 1 shows the D-L characteristic for a code-block b, having distortions

$${D}_{b}^{( t )}$$

and lengths

$${L}_{b}^{( t )}$$

at each candidate truncation point t. Those truncation points p that lie on the convex hull 110 of the D-L characteristic are shown as shaded dots 120a-e, while those truncation points that do not lie on the convex hull 110 are shown as open circles 130a-f. The distortion-length slopes associated with truncation points b on the D-L convex hull are denoted

$${S}_{b}^{( t )}$$

and two of these 140a-b are explicitly identified in the figure.

For PCRD-opt based rate-control, it is both sufficient and convenient to summarise the D-L characteristic for code-block b via a sequence of slope-length pairs

$$( {S}_{b}^{( t )} , {L}_{b}^{( t )} ) ,$$

corresponding to the truncation points t that lie on the distortion-length convex hull. Specifically,

$${S}_{b}^{( t )} = \{ \begin{matrix}∞ & if t = 0 \\ \frac{{D}_{b}^{( {𝒫}_{b} ( t ) )} - {D}_{b}^{( t )}}{{L}_{b}^{( t )} - {L}_{b}^{( {𝒫}_{b} ( t ) )}} & if t > 0 lies on the D - L convex hull \\ 0 & if t does not lie on the D - L convex hull\end{matrix} , \qquad ( 1 )$$

where [symbol] _{b}(t) denotes the previous truncation point t on the D-L convex hull, if there is one.

$${S}_{b}^{( t )}$$

is a distortion-length slope, which represents the incremental reduction in distortion, divided by the increase in coded length, relative to the previous convex hull point [symbol] _{b}(t). Note that

$$( {D}_{b}^{( 0 )} , {L}_{b}^{( 0 )} )$$

is always a convex hull point, having length

$${L}_{b}^{( 0 )} = 0$$

(empty bit-stream) and distortion

$${D}_{b}^{( 0 )} = {E}_{b} ,$$

which is just the energy of the original code-block samples. This first point is assigned a distortion-length slope of

$${S}_{b}^{( 0 )} = ∞ .$$

Notice also that

$${S}_{b}^{( t )}$$

is assigned to 0 here if t does not lie on the D-L convex hull. This is just a convenient way to distinguish between points that lie on the D-L convex hull and those that do not, since the ratio on the right-hand side of (1) cannot be 0.

The PCRD-opt algorithm, that selects optimal truncation points t_{b} for each code-block b, can simply assign

$$[ PCRD - opt assignment ] {t}_{b}^{opt} ( λ ) = max \{ t \vert {S}_{b}^{( t )} > λ \} , \qquad ( 2 )$$

where λ is a global distortion-length slope thresholds that is adjusted so that the overall coded length

$$L ( λ ) = {\sum }_{b} {L}_{b}^{( {t}_{b}^{o p t} ( λ ) )}$$

satisfies the rate-control objectives, as explained in [2].

The key idea in the JSIV framework [1] is to use an effective D-L characteristic for each code-block b in the current frame k_{cur}, which takes into account the fact that a decoder can use the same code-block in a previous video frame

$${k}_{b}^{ref} < {k}_{cur}$$

as a “reference block.” In the original JSIV framework, it is assumed that the decoder will use this reference block to reconstruct the current frame if the current frame's representation for the code-block is empty (no bytes at all). To deduce the effective D-L characteristic for each code-block b based on this assumed decoding policy, JSIV needs access to a quantity

$${D}_{b}^{M} ,$$

which can be interpreted as “motion distortion,” or just “temporal distortion,” since temporal change might arise for reasons other than scene motion. Assuming that the reference block is available with quantization distortion

$${D}_{b}^{ref}$$

and that quantization errors are uncorrelated with motion/temporal errors, a decoder that receives an empty code-block (no coded data at all), will experience distortion

$${\overline{D}}_{b}^{( 0 )} = {D}_{b}^{ref} + {D}_{b}^{M}$$

by using the reference code-block instead. In general, the effective D-L characteristic for the code-block has a different convex hull, identified here as its “JSIV hull.”

To facilitate the discussion in this document, it is convenient to use the term “INTRA hull” for the convex hull of the D-L characteristic when the availability of a reference code-block is ignored. These concepts are illustrated in FIG. 2, which has been adapted from [1]. One minor subtlety worth pointing out here is that there should always be at least one point t on a block's D-L characteristic for which the length

$${L}_{b}^{( t )}$$

is non-zero, even if all original samples in the block are identically zero, so that the opportunity always exists for the JSIV server (or encoder) to include a non-empty bit-stream for blocks with high temporal distortion; otherwise, there may be no way to prevent the JSIV client (or decoder) from continuing to use an inappropriate reference block. In JPEG 2000, at least, it is always possible to arrange for a code-block bit-stream to be non-empty yet decode to all zero-valued samples, so this subtle issue does not present any difficulty in practice.

FIG. 2: Effective D-L characteristic for a code-block b, where the decoder has access to a reference block in a preceding frame with distortion

$${D}_{b}^{ref}$$

and temporal distortion

$${D}_{b}^{M} .$$

Candidate truncation points that lie on the convex hull of the effective D-L characteristic, known as the block's “JSIV hull” 210, are shown as shaded dots 230a-d. Notice that truncation point t=2 240 that lies on the block's “INTRA hull” 220, does not lie on its JSIV hull 210. The JSIV transition point here is t̅_̅{̅b̅}̅=4 230b, and its slope on the JSIV hull is S̅_{b} 250, which is significantly smaller than its INTRA hull slope

$${S}_{b}^{( 4 )}$$

260 at the same truncation point 230b, due to the reduction in effective distortion from

$${D}_{b}^{( 0 )} to {\overline{D}}_{b}^{( 0 )} = {D}_{b}^{ref} + {D}_{b}^{M}$$

when the code-block bit-stream is empty.

Notice that the difference between the JSIV hull 210, which considers the reference block, and the INTRA hull 110, 220 shown in FIG. 1, which ignores the availability of any reference block, is captured completely by a “JSIV transition point” t̅_̅{̅b̅}̅, and a “JSIV transition slope”

$${\overline{S}}_{b} = \frac{{\overline{D}}_{b}^{( 0 )} - {D}_{b}^{( \overline{{t}_{b}} )}}{{L}_{b}^{( \overline{{t}_{b}} )}} = \frac{{D}_{b}^{M} + {D}_{b}^{r e f} - {D}_{b}^{( \overline{{t}_{b}} )}}{{L}_{b}^{( \overline{{t}_{b}} )}} , \qquad ( 3 )$$

These correspond to the first non-empty (non-zero length) truncation point on the JSIV hull and the effective D-L slope at that first truncation point. If there is no such transition point, S̅_{b} is taken to be infinite.

In the most general context, JSIV is used to disseminate JPEG 2000 encoded video content to one or more clients (decoders) that may each have different bandwidth constraints and may have existing content for the current frame and/or any number of preceding frames, with non-uniform levels of quality in each code-block. A JSIV server optimises the real-time dissemination of code-block bit-stream content to these clients by using the D-L characteristics and temporal distortion estimates for each code-block, along with knowledge of each client's existing content.

The main challenge in this general JSIV context is determining the temporal distortion terms

$${D}_{b}^{M} ,$$

which may be different for each client, depending on which frame k contains the highest quality reference block within the client's cache. That is, a completely general JSIV server needs access to a set of temporal distortion terms

$${D}_{b , {k}^{′} \to {k}_{curr}}^{M} ,$$

corresponding to each frame k′<k_{cur} that could be used as the reference frame

$${k}_{b}^{ref}$$

for block b. [1] explores various strategies for estimating the

$${D}_{b , {k}^{′} \to {k}_{curr}}^{M} ,$$

including a simple strategy in which

$${D}_{b , k \to {k}_{cur}}^{M}$$

is formed simply by adding “one-hop” temporal distortions

$${D}_{b , k}^{M} = {D}_{b , k - 1 \to k}^{M}$$

for each k from k′+1 to k_{cur}. The advantage of such an approach is that only one “one-hop” distortion term

$${D}_{b , k}^{M}$$

need be calculated and stored for each code-block b in each frame k. We note that the original JSIV algorithm, described in [1], operates on JPEG 2000 precincts, rather than directly on code-blocks, where a precinct usually consists of one code-block from each of the HL, LH and HH DWT sub-bands at a given resolution. This allows the incremental dissemination of content to each client to be performed using JPIP (JPEG 2000 Internet Protocol) [3], while also reducing the number of distortion values that need to be recorded by a factor of 3; however, there is no conceptual difference between applying the method to code-blocks and applying it to precincts.

The JSIV approach can also be used as a live video encoding strategy. In this context, a single client (decoder) is assumed, which has no pre-existing cached content for the current frame but has access to all of the encoded content from previous frames. In this, much simpler context, the PCRD-opt rate control algorithm, that is applied in each frame of the video, uses the effective D-L characteristic for each code-block b, in which the first D-L pair

$$( {D}_{b}^{( 0 )} , {L}_{b}^{( 0 )} = 0 )$$

is replaced by

$$( {\overline{D}}_{b}^{( 0 )} , {L}_{b}^{( 0 )} = 0 ) , where {\overline{D}}_{b}^{( 0 )} = {D}_{b}^{ref} + {D}_{b}^{M} ,$$

as explained above. Here the reference frame

$${k}_{b}^{ref}$$

is the most recent frame for which a non-empty bit-stream was delivered for code-block b, since this is the one that the single assumed JSIV client should have in its cache, for use as a reference in the event that there is no non-empty contribution for code-block b in the current frame.

Thus, a live JSIV-based video encoding strategy needs to keep track of the most recent frame for which a non-empty bit-stream was delivered for code-block b, always using this as the reference frame

$${k}_{b}^{ref}$$

in the current frame k_{cur}; along with this it needs to keep track of or be able to deduce the distortion

$${D}_{b}^{ref} = {D}_{b , {k}_{b}^{ref}}^{( {p}_{opt} )}$$

associated with this most recent non-empty bit-stream, and it needs to compute or estimate the temporal distortion

$${D}_{b}^{M} = {D}_{b , {k}_{b}^{ref} \to {k}_{cur}}^{M} .$$

This last task can be achieved using a frame buffer, organized into code-blocks, which keeps track of one set of sample values for each code-block b, corresponding to the most recent frame k in which the truncated bit-stream for code-block b was non-empty. Then

$${D}_{b}^{M}$$

is computed by summing the squared differences between the current frame's samples for block b and those found within the frame buffer for block b.

Out of all of these elements, by far the most costly for a practical video encoder is the frame buffer. The amount of memory required by the frame buffer is orders of magnitude larger than that required for the other quantities mentioned above, so that this memory cannot be managed entirely on-chip for larger video frame sizes. High bandwidth external memory can consume large amounts of power, compared to other aspects of the video encoder, quite apart from its impact on manufacturing costs.

One well recognized technique to address the high cost of a frame buffer is to apply lightweight compression techniques to the contents of the frame buffer, especially lossy compression techniques that allow the memory bandwidth associated with frame buffer access to be tightly constrained, regardless of the statistical properties of the sample data—see [4] for example.

However, such techniques are still expensive and the size of a compressed frame buffer can still be quite substantial. Therefore, there is a need for alternative techniques to address the high cost of a frame buffer.

### SUMMARY OF THE INVENTION

In contrast to approaches applying compression techniques to the contents of the frame buffer, this disclosure describes methods for estimating

$${D}_{b}^{M}$$

that avoid the need for a frame buffer altogether. This disclosure also describes methods that use the

$${D}_{b}^{M}$$

value to pre-estimate the quality to which each block should be encoded, so as to limit the complexity of JSIV based video encoding.

An embodiment provides a method for encoding a sequence of video frames, each having been transformed to produce a plurality of sample blocks, the method involving:
recording, in a reference record, information for a reference block that was encoded in a previous frame of the video sequence, the reference record recording at least: a set of summary values for the reference block, a number of summary values in the set being smaller than a number of samples in the block, and information related to the quality of the encoded reference block;
estimating temporal distortion between the reference block and a corresponding block of the current frame, identified here as the current block, based on a set of summary values for the current block and the corresponding set of summary values for the reference block that are stored within the reference record;
determining a lower bound on an encoded quality level to which the current block should be encoded in order for the block's encoded representation to be considered for inclusion in the encoded video stream, based on the estimated temporal distortion together with information related to the quality of the reference block, this bound being identified here as the JSIV transition point;
encoding the sample values of the current block to one or more encoded quality levels;
selecting the encoded quality level to which each block in a plurality of sample blocks in the current frame is encoded, taking into account the JSIV transition point, so that the overall encoded length of the plurality of blocks does not exceed a specified length constraint; and
updating the reference record with information derived from the current block, in the event that the coded representation of the current block that is included in the encoded video stream reaches at least the lower bound identified by the JSIV transition point.

In some embodiments the summary values are obtained using linear projection onto a set of projection vectors, wherein the set of summary values for the current block and the corresponding set of summary values of its reference block, are obtained using the same set of projection vectors.

In some embodiments the coefficients of each projection vector are derived using a pseudo-random number generator.

In some embodiments the coefficients of each projection vector are either 1 or 0, the total number of 1's in the complete set of projection vectors for a block is equal to the number of samples in the block and the projection vectors are mutually orthogonal.

In some embodiments the coefficients of each projection vector are either 1 or −1.

In some embodiments the temporal distortion estimate is derived from the sum of squared differences between the summary values for the current block and the summary values for the reference block.

In another embodiment the method further comprises a pre-estimation step that estimates the JSIV transition point without first encoding the current block, by using the estimated temporal distortion, together with information related to the encoded quality level of the reference block.

In some embodiments the pre-estimation step also estimates a coded length associated with each one of a plurality of potential encoded quality levels for the current block.

In some embodiments the pre-estimation step uses the estimated JSIV transition point and estimated coded length values, for the current block and any other block within a plurality of sample blocks in the current frame whose overall encoded length should not exceed the specified length constraint, without first encoding all of said sample blocks, to estimate an encoded quality level and associated coded length for each of said blocks such that the overall encoded length will not exceed the specified length constraint.

In some embodiments the current block is subsequently encoded to the estimated encoded quality level determined by the pre-estimation step.

In some embodiments the current block is subsequently encoded to each one of a plurality of encoded quality levels, where the range of said plurality of encoded quality levels is based on the estimated quality levels determined by the pre-estimation step.

In some embodiments the method further comprises a rate distortion optimising step which selects a final encoded quality level for the encoded representation of the current block from the plurality of encoded quality levels to which it has been encoded, using information regarding the encoded lengths and associated impact on image distortion determined during the block encoding process, together with the estimated block temporal distortion value.

In some embodiments a plurality of blocks are collected into groups, such that each current block in a current group has an associated reference block that was encoded in the same previous frame, these reference blocks forming a reference group, wherein: a) one reference record is maintained for each group, rather than each individual block; b) one temporal distortion value is estimated for each group, rather than each block, based on a set of summary values for the group and a corresponding set of summary values for the reference group that are stored in the reference record, a number of summary values in the set for the group being smaller than a number of samples within all blocks of the group; c) a JSIV transition point is determined for the group, establishing a lower bound on the encoded quality level for all blocks in the group; d) the encoded quality level to which each block in a plurality of sample blocks in the current frame is encoded is selected, taking into account the group JSIV transition point, so that the overall encoded length of the plurality of blocks does not exceed a specified length constraint; and e) the reference record for the group is updated in the event that the coded representation of the blocks from the group that is included in the encoded video stream reaches at least the lower bound identified by the group's JSIV transition point.

In some embodiments the summary values are obtained using linear projection onto a set of projection vectors, wherein the set of summary values for a group and the corresponding set of summary values for its reference group are obtained using the same set of projection vectors.

The projection vectors can be formed using any of the methods described above.

In some embodiments the temporal distortion estimate is derived from the sum of squared differences between the summary values for the current group and the summary values for the reference group.

In some embodiments the method further comprises a pre-estimation step that estimates the JSIV transition point for the current group without first encoding the blocks of the group, by using the group's estimated temporal distortion, together with information related to the encoded quality level of the reference blocks in the reference group.

In some embodiments the pre-estimation step also estimates the coded length associated with a plurality of potential qualities for all blocks in the current group.

In some embodiments the pre-estimation step uses the estimated JSIV transition point and estimated coded length values, for the current group and any other group containing blocks within the plurality of blocks of the current frame, whose overall encoded length should not exceed the specified length constraint, without first encoding all of said sample blocks, to estimate an encoded quality level and associated coded length for each of said blocks such that the overall encoded length will not exceed the specified length constraint.

In some embodiments the blocks of the current group are subsequently encoded to the estimated quality level determined by the pre-estimation step.

In some embodiments the blocks of the current group are subsequently encoded to each one of a plurality of encoded quality levels, where the range of said plurality of encoded quality levels is based on the estimated encoded quality level determined by the pre-estimation step.

In some embodiments the method further comprises a rate distortion optimising step which selects the final quality for the encoded representation of each block of the current group from the plurality of encoded quality levels to which it has been encoded, using information regarding the encoded lengths and associated impact on image distortion determined during the block encoding process, together with the estimated group temporal distortion value.

In some embodiments the quality of the encoded representation of a block within the encoded video stream is increased to a level commensurate with that of blocks having no reference block, if more than a specified number of frames have elapsed since the coded representation of the block that was included in the encoded video stream reached at least the lower bound identified in each of those frames by the corresponding JSIV transition point.

Another embodiment provides a system for encoding a sequence of video frames, each having been transformed to produce a plurality of sample blocks, the system comprising:
memory configured to store:
   a reference record recording information for a reference block that was encoded in a previous frame of the video sequence, the reference record recording at least: a set of summary values for the reference block, a number of summary values in the set being smaller than a number of samples in the block, and information related to the quality of the encoded reference block;
processing logic configured to:
   estimate temporal distortion between the reference block and a corresponding block of the current frame, identified here as the current block, based on a set of summary values for the current block and the corresponding set of summary values for the reference block that are stored within the reference record;
   determine a lower bound on an encoded quality level to which the current block should be encoded in order for the block's encoded representation to be considered for inclusion in the encoded video stream, using the estimated temporal distortion together with information related to the quality of the reference block, recovered from the reference record, this bound being identified here as the JSIV transition point;
   encode the sample values of the current block to one or more encoded quality levels;
   select the encoded quality level to which each block in a plurality of sample blocks in the current frame is encoded, taking into account the JSIV transition point, so that the overall encoded length of the plurality of blocks does not exceed a specified length constraint; and
   update the reference record with information derived from the current block, in the event that the coded representation of the current block that is included in the encoded video stream reaches at least the lower bound identified by the JSIV transition point.

### 4 BRIEF DESCRIPTION OF THE DRAWINGS

FIG. 1: Shows a graph of D-L characteristic for a code-block b, having distortions

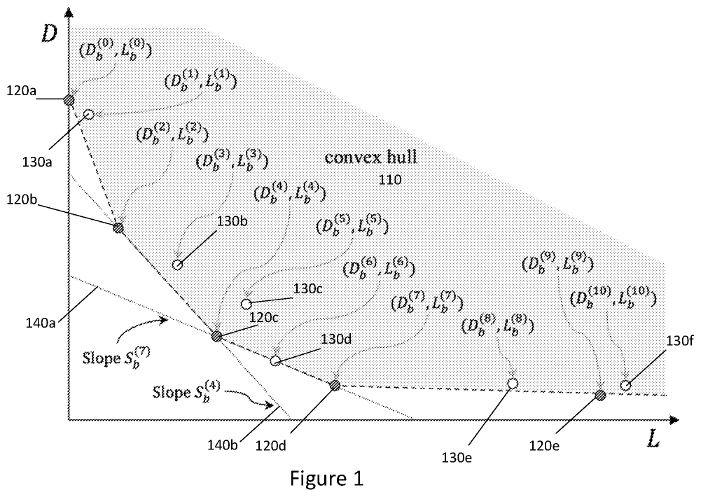

$${D}_{b}^{( t )}$$

and lengths

$${L}_{b}^{( t )}$$

at each candidate truncation point t.

FIG. 2: Shows a graph of effective D-L characteristic for a code-block b, where the decoder has access to a reference block in a preceding frame with distortion

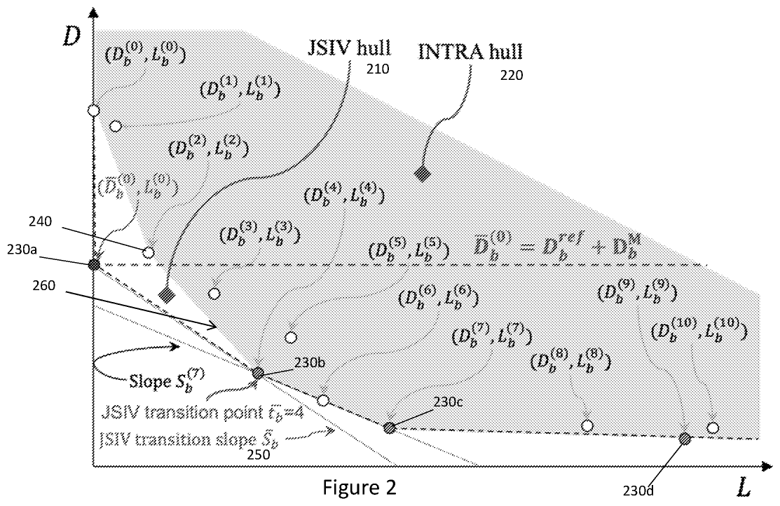

$${D}_{b}^{ref}$$

and temporal distortion

$${D}_{b}^{M} .$$

FIG. 3: Is a block diagram providing an Overview of some of the most important aspects of the invention, including: temporal distortion estimation (1^{st} aspect); pre-estimation of the JSIV transition point and PCRD-opt truncation point ahead of actual coding (2^{nd} aspect); and final slope estimation and PCRD-opt rate control, which determines how each block bit-stream should be truncated and also when a block's reference record should be updated (4^{th} aspect).

FIG. 4: Is a block diagram illustrating an example implementation of the projection method, based on complete partial sums.

FIG. 5: Shows graphs of cumulative distribution functions.

FIG. 6: Is a graph illustrating the fact that the JSIV transition point must lie on the INTRA hull if

$${\overline{D}}_{b}^{( 0 )} < {D}_{b}^{( 0 )} ,$$

by assuming otherwise and showing a contradiction.

FIG. 7: Is a graph showing over-estimation of the JSIV transition point.

### 5 DETAILED DESCRIPTION

This invention relates to video encoding, including scalable interactive delivery of video. More specifically, it relates to the encoding or scalable interactive delivery of a sequence of video frames with non-uniform quality, such that the quality of any given spatial region within a frame generally varies from frame to frame within the sequence, so as to optimise the decoded quality subject to bandwidth constraints and the use of a decoder that is able to utilise higher quality information from previous frames, where available.

Specifically, this invention provides methods for estimating the temporal distortion between corresponding code-blocks in different frames, which do not require the use of frame buffers, along with methods for using these temporal distortion estimates to deduce the quality to which each code-block should be encoded, so as to reduce both memory and encoding complexity.

The methods described in this disclosure are applicable both in the context of fully embedded block coding algorithms, such as that defined in JPEG 2000 Part-1, and in the context of non-embedded or partially embedded block coding algorithms, such as that defined in JPEG 2000 Part-15, but the methods may be applied more broadly to any encoding technology that partitions the original video frames into elements that are independently coded, whether in the image domain or a transform domain, such that the encoded elements can have non-uniform quality.

As discussed above, this disclosure describes methods for estimating

$${D}_{b}^{M}$$

that avoid the need for a frame buffer altogether.

The key idea in the JSIV framework [1] is to use an effective D-L characteristic for each code-block in the current frame, which takes into account the fact that a decoder can use the same code-block in a previous video frame as a “reference block.” To achieve this, some information about the reference block must be preserved between frames, which can become expensive if this is done in the most obvious way, via a frame buffer, organized into code-blocks, which keeps track of one set of sample values for each code-block b, corresponding to the most recent frame k in which the truncated bit-stream for code-block b was non-empty.

It is worth noting that the existing JSIV framework is effectively a form of “conditional replenishment,” where non-empty code-blocks within the current frame are used to update (or “replenish”) the corresponding sample values within the decoder, while empty code-blocks retain their previous values—i.e., they are not replenished, but are drawn from the most recent frame in which the code-block bit-stream was non-empty. As with other conditional replenishment schemes that are used for directly encoding a video stream, as opposed to managing the interaction with each client separately in a client-server setting, it is desirable to ensure that all code-blocks are replenished at least from time to time, regardless of whether or not there is any temporal distortion. This allows decoders to start decoding from an arbitrary point in the communicated video stream and is also important for limiting the temporal propagation of communication errors. This invention describes methods that adjust the distortion-length slopes

$${S}_{b}^{( p )}$$

so as to reduce the impact of communication errors and allow decoders to start decoding from an arbitrary point in the video stream.

Conditional replenishment has a very long history of application within video codecs. Since the earliest video coding standards, such as H.261, conditional replenishment has been an important mode for block-based motion compensated video codecs, which can explicitly identify (e.g., through mode flags) blocks that are not updated (not replenished) with new data in a given frame. H.261 specifically requires the periodic replenishment of all macro-blocks (also known as “intra blocks”) over a specified interval, to address the need for decoders to join the encoded video sequence at an arbitrary point, the importance of which has already been mentioned above.

Apart from operating in the image domain, rather than the wavelet domain, the main distinction between conditional replenishment based video codecs and JSIV is that JSIV is an open-loop scheme that does not require the decoder to adopt a prescribed strategy for processing the content that it receives; by contrast, most video codecs employ a closed-loop approach, where the decoder progressively updates at least one frame buffer that is replicated within the encoder. The JSIV server or encoder makes rate-distortion optimizing decisions (PCRD-opt on the JSIV hull of each code-block) regarding the content that it sends to a remote client or decoder, based on an assumption that the decoder will employ a sensible method for reconstructing the non-uniform quality content that it receives, but the decoder has the freedom to use its reference buffer in any manner it sees fit.

In particular, a JSIV based video decoder does not actually need to maintain a frame buffer that is synchronized with one in the encoder; in fact, it does not need to buffer decoded video samples at all, but it does generally need to maintain a reference buffer containing the most recent non-empty code-block bit-stream for each block b. That is, the decoder needs to maintain some form of code-block cache, which will usually be done in the compressed domain.

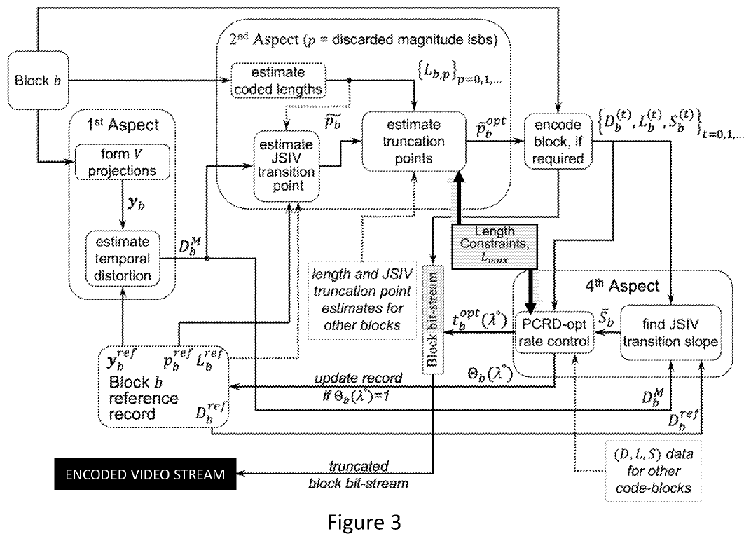

FIG. 3 illustrates an overview of some of the most important aspects of the invention, including: temporal distortion estimation (1^{st} aspect); pre-estimation of the JSIV transition point and PCRD-opt truncation point ahead of actual coding (2^{nd} aspect); and final slope estimation and PCRD-opt rate control, which determines how each block bit-stream should be truncated and also when a block's reference record should be updated (4^{th} aspect).

The block diagram in FIG. 3 shows how some of the most important aspects of the invention work together to produce an encoded video stream.

A first aspect of the invention consists of methods to estimate the temporal distortion

$${D}_{b}^{M} = {D}_{b , {k}_{b}^{ref} \to {k}_{c u r}}^{M}$$

between reference frame

$${k}_{b}^{ref}$$

and the current frame k_{cur}, without the need for a frame buffer. These methods involve computation and storage of a set of V projections, preferably with weights drawn from the set {−1,0,1}, which can be converted into temporal distortion estimates. In these methods, each code-block b is assigned a “reference record” that preserves a set of summary values for the code-block, including information from a set of V projections from the most recent reference frame

$${k}_{b}^{ref} .$$

Only summary values are preserved and there is no need to preserve the code-block's sample values themselves. Each reference record starts out in an “empty” state corresponding to the absence of any reference and is updated after the code-block contributes to the encoded video stream in a way that will be recognized by the decoder as providing a new high quality reference for the block.

A second aspect of the invention consists of methods that allow the JSIV transition point t̅_̅{̅b̅}̅ for a block b to be estimated, along with the truncation point

$${t}_{b}^{opt}$$

that will be produced by the PCRD-opt rate control procedure, without actually performing the block encoding operation. These methods use estimates of the coded lengths

$${L}_{b}^{( t )}$$

that will eventually be produced by the block encoding procedure, along with the temporal distortion estimates

$${D}_{b}^{M}$$

produced by the first aspect of the invention. In preferred embodiments of the invention, all of these estimates are represented in terms of the number of least significant magnitude bit-planes to discard, p, so that the estimated JSIV transition point is expressed as [symbol] , estimated lengths are expressed as L_{b,p} and the estimated truncation point is expressed as

$${\tilde{p}}_{b}^{opt} ,$$

as shown in FIG. 3. This aspect of the invention allows the encoding of some (perhaps most) of the code-blocks to be avoided altogether. If a fully embedded block coder is employed, such as the one defined by JPEG 2000 Part-1, this aspect of the invention can be used to limit the number of coding passes that must be performed during block encoding. Moreover, this aspect of the invention allows the efficient use of non-embedded block coding algorithms, including the algorithm defined by JPEG 2000 Part-15. This aspect of the invention requires one or two additional summary values to be recorded within each block's reference record, in addition to information from the V projection values mentioned above.

A third aspect of the invention shows how the methods of the first two aspects of the invention can be applied to groups of related code-blocks, such as co-located code-blocks from the HL, LH and HH sub-bands from the same resolution of a discrete wavelet transform and co-located code-blocks from each colour component. Working with groups, rather than individual code-blocks, is not itself a departure from the JSIV framework. In fact, the JSIV approach originally described in [1] was developed and experimentally validated based on JPEG 2000 “precincts,” where all but the lowest resolution precincts consisted of three co-located code-blocks—one from each of the HL, LH and HH sub-bands at the same resolution of a given colour component. However, working with groups allows a significant reduction in memory and computation, since information about only one set of V projections needs to be stored per group of code-blocks to estimate temporal distortion, rather than one set for each individual code-block. In particular, this aspect of the invention allows only one reference record to be maintained for each group of blocks, rather than one for each block.

A fourth aspect of the invention provides methods for computing and adjusting D-L slope values, after completion of the relevant block encoding steps, these slopes being presented to the PCRD-opt rate control procedure to determine the final code-block truncation points

$${t}_{b}^{opt}$$

and hence the coded content that ultimately forms the encoded video stream. This aspect of the invention introduces an opportunity for “soft quality modulation,” whereby a code-block (or group of blocks) that does not differ sufficiently from its reference to become a new reference for future video frames need not necessarily be assigned an entirely empty block bit-stream. Soft quality modulation imposes stronger assumptions on the behaviour of a JSIV decoder, but presents a number of significant potential quality of service benefits.

A fifth aspect of the invention consists of periodic refresh methods that can be used to improve the initial quality experienced by clients (decoders) that start decoding from an arbitrary point in the encoded video stream.

### Brief Note on Terminology

Unless specifically stated otherwise, in this document the term “distortion” is used to refer to a level of quantization error, such that a low distortion is equivalent to a high encoded quality while a high distortion is equivalent to a low encoded quality. The only common exception to this usage is the phrase “temporal distortion”

$$( i . e . , {D}_{b}^{M} ) ,$$

which is not directly related to quantization errors or encoded quality, but rather temporal change. Both quantization distortion and temporal distortion, however, use the same metric, which is usually an effective squared error or visually weighted squared error in the image (i.e., frame) domain. Although both types of distortion use the same metric, they may have differing perceptual significance. For example, temporal distortion can sometimes be perceived in the form of inter-frame flickering, where a similar level of quantization distortion cannot be perceived within a still image. Such differences in perceptual significance, however, can readily be addressed by applying different scaling factors to quantization and temporal distortion terms, as found in the various methods disclosed by this invention.

While the term code-block is borrowed from the JPEG 2000 family of standards, and JPEG 2000 based encoding of the individual video frames is a primary application for the invention, the methods of the invention are by no means limited to JPEG 2000. Indeed, the methods of the invention can be applied with any coding technology that allows blocks, or even arbitrary regions, of images samples or transformed image samples to be coded with their own level of quality, that may differ from the quality to which other blocks or regions of samples are coded.

### 6 DETAILED DESCRIPTION OF THE ASPECTS OF THE INVENTION

### 6.1 1^{st} Aspect: Memory Efficient Estimation of Temporal Distortion

Embodiments of the invention form a compact representation of each code-block, consisting of summary values that can be recorded within a small amount of memory, ideally directly on-chip or within a processor's cache, for the purpose of estimating the temporal distortion

$${D}_{b}^{M}$$

between code-block b in the current frame k_{cur} and a reference version of the code-block in frame

$${k}_{b}^{ref} .$$

Preferred embodiments of the invention form this compact representation by linear projection of the code-block samples onto a small collection of orthogonal vectors, whose elements are drawn from an alphabet [symbol] ⊆{1,0,−1}, so that the projection operation requires only addition and subtraction operations, without any multiplication.

Specifically, write x_{b}[n] for the sample values associated with code-block b and write

$${x}_{b}^{ref} [ n ]$$

for the corresponding reference block samples, in frame

$${k}_{b}^{ref} ,$$

where n is a 2-dimensional index that enumerates all samples belonging to the block. The temporal distortion that needs to be estimated is the total squared error in the current reconstructed video frame that could be attributed to replacing all of the code-block's current samples x_{b}[n] with their reference values

$${x}_{b}^{ref} [ n ] .$$

In the absence of any transform, this can be expressed simply as

$${D}_{b}^{raw} = {\sum }_{n} {( {x}_{b} [ n ] - {x}_{b}^{ref} [ n ] )}^{2}$$

In preferred embodiments of the invention, the code-block samples are sub-band samples from transformed representations of the video frames in question. Writing G_{b} for the synthesis energy gain factor associated with the sub-band to which code-block b belongs, which is just the squared Euclidean norm of the synthesis basis functions for that sub-band, and assuming an orthogonal or nearly orthogonal transform, or at least a lack of strong correlation between the sample errors

$${x}_{b} [ n ] - {x}_{b}^{ref} [ n ] ,$$

the image domain temporal distortion can be well approximated by

$${D}_{b}^{M} = {G}_{b} \times {D}_{b}^{raw}$$

In many embodiments, the image-domain distortion of interest is not simply total squared error, but visually weighted squared error. This is easily accommodated simply by incorporating the relevant visual weighting factors into the energy gain terms G_{b}.

In some embodiments of the invention, the sample values x_{b}[n] and

$${x}_{b}^{ref} [ n ]$$

are quantized sample values, that have been produced by quantizing the relevant sub-band samples using a quantizer with step size Δ_{b}. In this case, the relationship between

$${D}_{b}^{raw} and {D}_{b}^{img}$$

is modified to

$${D}_{b}^{M} = {G}_{b} {Δ}_{b}^{2} \times {D}_{b}^{raw}$$

In general, therefore, the image-domain distortion of interest can be written as

$${D}_{b}^{M} = {ϕ}_{b} {\sum }_{n} {( {x}_{b} [ n ] - {x}_{b}^{ref} [ n ] )}^{2} , \qquad ( 4 )$$

where the strictly positive distortion scaling factor φ_{b} is variously G_{b}, with or without visual weighting, or

$${G}_{b} {Δ}_{b}^{2} .$$

The projection method for estimating

$${D}_{b}^{M}$$

involves computing a set of V inner products

$${y}_{b , v} = 〈 {x}_{b} , {e}_{b , v} 〉 = {\sum }_{n} {x}_{b} [ n ] \cdot {e}_{b , v} [ n ] , for v ∈ \{ 0 , 1 , ... , V - 1 \} ,$$

where the projection vectors e_{b,v}, having coefficients e_{b,v}[n], are preferably constructed in the same way for each code-block b, with all e_{b,v}[n] drawn from [symbol] ⊆{1,0,−1}. As mentioned, this means that the computation of each projection value y_{b,v} involves at most addition and subtraction.

Linear projection has the desirable property that it commutes with the temporal differencing operation, so that

$$〈 {x}_{b} - {x}_{b}^{ref} , {e}_{b , v} 〉 = 〈 {x}_{b} , {e}_{b , v} 〉 - 〈 {x}_{b}^{ref} , {e}_{b , v} 〉 = {y}_{b , v} - {y}_{b , v}^{ref}$$

For blocks from high-frequency sub-bands (everything other than a base or LL sub-band), the y_{b,v} values can all be understood as realisations of a zero mean random process, so it is reasonable to assume that the temporal differences

$${y}_{b , v} - {y}_{b , v}^{ref}$$

can also be understood as realisations of a zero mean random process. Then, if the projection V vectors {e_{b,v}}ᵥ for block b are mutually orthogonal, or nearly so, the temporal distortion estimates

$${D}_{b}^{M}$$

can be well approximated by

$${D}_{b}^{M} = {A}_{b} \cdot {ϕ}_{b} \cdot \frac{{\sum }_{v = 0}^{V - 1} {( {y}_{b , v} - {y}_{b , v}^{ref} )}^{2}}{{\sum }_{v = 0}^{V - 1} {‖ {e}_{b , v} ‖}^{2}} = {A}_{b} \cdot {ϕ}_{b} \cdot \frac{{‖ {y}_{b} - {y}_{b}^{ref} ‖}^{2}}{{\sum }_{v = 0}^{V - 1} {‖ {e}_{b , v} ‖}^{2}} , \qquad ( 5 )$$

for sufficiently large V. Here, A_{b} is the area (total number of samples) of code-block b y_{b} and

$${y}_{b}^{ref}$$

are the V-element vectors composed from the projection values y_{b,v} and

$${y}_{b}^{ref} ,$$

respectively.

In preferred embodiments of the invention, the projection vectors are constructed in such a way as to avoid systematic patterns, so as to maximize the reliability of the approximation when temporal errors follow a consistent pattern. In particular, some embodiments of the invention use a pseudo-random number generator to dynamically construct the projection vectors.

The relationship in equation (5) is easy to establish under the condition that the temporal differences

$$( {x}_{b} [ n ] - {x}_{b}^{ref} [ n ] )$$

are realisations of a sequence of zero mean uncorrelated random variables with variance

$${σ}_{b}^{2} ;$$

in this case the expected value for the temporal distortion is

$${A}_{b} {ϕ}_{b} {σ}_{b}^{2} ,$$

while the

$${y}_{b , v} - {y}_{b , v}^{ref}$$

are themselves realisations of underlying zero mean random variables

$${Y}_{b , v}^{diff} ,$$

each of which has variance σ²∥e_{b,v}∥². If the projection vectors are orthogonal, the

$${Y}_{b , v}^{diff}$$

are uncorrelated, so σ² can be estimated from the sum of the squared realisations

$${( {y}_{b , v} - {y}_{b , v}^{ref} )}^{2}$$

divided by the sum of the scaling factors ∥e_{b,v}∥²= [symbol] e_{b,v}, e_{b,v} [symbol] , which completes our brief explanation of equation (5). In fact, the random variables

$${Y}_{b , v}^{diff}$$

should be nearly Gaussian distributed, by virtue of the well known Central Limit Theorem, and this property holds even if the

$$( {x}_{b} [ n ] - {x}_{b}^{ref} [ n ] )$$

values are realisations of correlated underlying random variables, subject to certain assumptions on the nature of the correlation.

It is worth noting that the projection method here is a form of Locality Sensitive Hashing (LHS). It should be apparent to those skilled in the art that other LHS techniques may be employed in the estimation of temporal distortion based on a small set of projections.

For blocks from a low-pass sub-band (i.e., a base or LL sub-band) it is not reasonable to assume that the temporal differences

$${y}_{b , v} - {y}_{b , v}^{ref}$$

have zero mean. However, the expected value of

$${x}_{b} [ n ] - {x}_{b}^{ref} [ n ]$$

can be estimated from the projections as

$${μ}_{b}^{diff} = \frac{{\sum }_{v = 0}^{V - 1} {y}_{b , v} - {y}_{b , v}^{ref}}{{\sum }_{v = 0}^{V - 1} μ ( {e}_{b , v} )} ,$$

where μ(e_{b,v})=Σₙe_{b,v}[n], from which the expected value of

$${y}_{b , v} - {y}_{b , v}^{ref}$$

can be estimated as

$$μ ( {e}_{b , v} ) \cdot {μ}_{b}^{diff} .$$

Using these, the temporal distortion for low-pass blocks can be approximated by

$${D}_{b}^{M} = {A}_{b} \cdot {ϕ}_{b} \cdot [ \frac{{\sum }_{v = 0}^{V - 1} {( {y}_{b , v} - {y}_{b , v}^{ref} )}^{2} - {( μ ( {e}_{b , v} ) \cdot {μ}_{b}^{diff} )}^{2}}{{\sum }_{v = 0}^{V - 1} {‖ {e}_{b , v} ‖}^{2}} + {( {μ}_{b}^{diff} )}^{2} ] .$$

Written out in full,

$${D}_{b}^{M} = {A}_{b} \cdot {ϕ}_{b} \cdot [ \frac{{\sum }_{v = 0}^{V - 1} {( {y}_{b , v} - {y}_{b , v}^{ref} )}^{2}}{{\sum }_{v = 0}^{V - 1} {‖ {e}_{b , v} ‖}^{2}} - \frac{{( {\sum }_{v = 0}^{V - 1} {y}_{b , v} - {y}_{b , v}^{ref} )}^{2} {\sum }_{v = 0}^{V - 1} {μ}^{2} ( {e}_{b , v} )}{{( {\sum }_{v = 0}^{V - 1} μ ( {e}_{b , v} ) )}^{2} {\sum }_{v = 0}^{V - 1} {‖ {e}_{b , v} ‖}^{2}} + \frac{{( {\sum }_{v = 0}^{V - 1} {y}_{b , v} - {y}_{b , v}^{ref} )}^{2}}{{( {\sum }_{v = 0}^{V - 1} μ ( {e}_{b , v} ) )}^{2}} ] . \qquad ( 6 )$$

In preferred embodiments of the invention, elements of the projection vectors are drawn from the reduced alphabet [symbol] ={1,0}, in which case each projection value y_{b,v} is a partial sum of the code-block sample values x_{b}[n], including just those samples for which e_{b,v}[n]=1. Moreover, in this case, mutual orthogonality of the projection vectors requires the non-zero coefficients in each vector to be non-overlapping with the non-zero coefficients of each other projection vector. As a result, these embodiments form disjoint partial sums of the code-block samples, so that a single adder can be shared by the machinery that computes all V projection coefficients—this is the primary reason for preferring such embodiments.

In preferred embodiments of the invention, it is also preferable for the V partial sums to be “complete,” meaning that each code-block sample should contribute to exactly one of the sums. In this case Σᵥ∥e_{b,v}∥² and Eᵥμ(e_{b,v}) are both equal to A_{b}, the number of samples in block b, which significantly simplifies the expressions above. Then equation (5) becomes

$${D}_{b}^{M} = {ϕ}_{b} \cdot [ {\sum }_{v = 0}^{V - 1} {( {y}_{b , v} - {y}_{b , v}^{ref} )}^{2}$$

and equation (6) becomes

$${D}_{b}^{M} = {ϕ}_{b} \cdot [ {\sum }_{v = 0}^{V - 1} {( {y}_{b , v} - {y}_{b , v}^{ref} )}^{2} + \frac{{( {\sum }_{ν = 0}^{V - 1} {y}_{b . ν} - {y}_{b , v}^{ref} )}^{2} ( {A}_{b} - {\sum }_{v = 0}^{V - 1} {μ}^{2} ( {e}_{b , v} ) )}{{A}_{b}^{2}} ] . \qquad ( 7 )$$

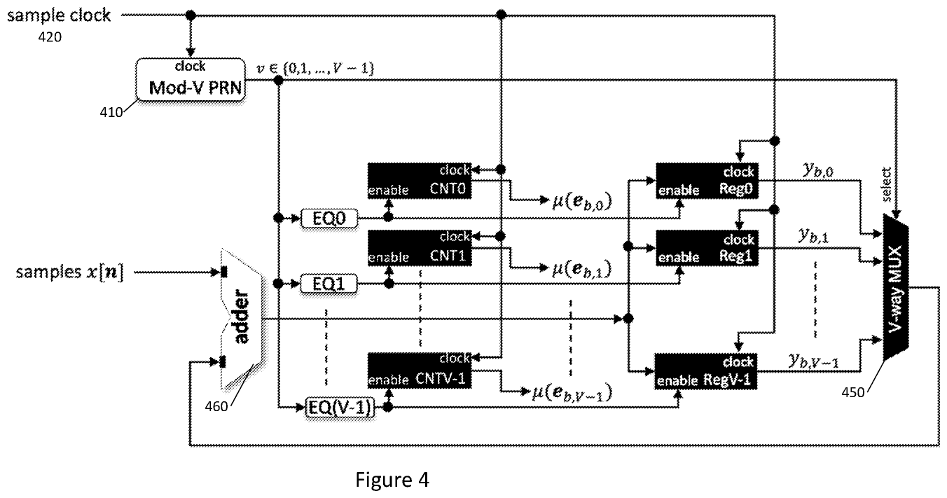

FIG. 4 shows an example implementation of the projection method, based on complete partial sums, which generates the orthogonal projection vectors dynamically using a pseudo-random number generator (Mod-V PRN) whose output v is approximately uniformly distributed over the set v∈{0, 1, . . . , V−1}. Only one adder 460 is required, with V accumulators, a V-way multiplexer (commutator) and V counters, so that both the y_{b,v} and μ(e_{b,v}) values can be computed dynamically from a sequential steam of the code-block samples. As noted above, the μ(e_{b,v}) values are needed only for low-pass code-blocks, but the more general approximation of equation (7) can always be used for both high-pass and low-pass code-blocks. Importantly, the PRN used in such implementations should start from the same state in every frame, so that projection values y_{b,v} and

$${y}_{b , v}^{ref}$$

are formed using the same projection vectors.

FIG. 4 illustrates an example implementation of the projection method, based on complete partial sums. The pseudo-random number generator 410, depicted as “Mod-V PRN” generates a pseudo-random sequence of outputs v that are approximately uniformly distributed over the interval [0, V), where the output v updates on each successive cycle of the sample clock 420, and the internal state of the Mod-V PRN 410 is reset at least at the start of each frame. V counters 430a-v determine the μ(e_{b,v}) for use with low-pass blocks (i.e., blocks from base or LL sub-bands)—these can be skipped when working only with high-pass blocks. In this example implementation, V separate registers 440a-v store the accumulation results y_{b,v}, corresponding to each v∈[0, V), and a multiplexer 450 selects one of these V registers as the one into which a new sample value x[n] should be accumulated, based on the output v from the pseudo-random number generator.

In practical applications, the sample values x[n] and accumulated projection values produced by these methods are preferably integers, but preferred embodiments of the invention compact these values prior to recording them as

$${y}_{b , v}^{ref}$$

when a block's reference record is updated. A good compaction strategy is to employ a “vector floating point format,” with a single exponent ∈_{b} and a set of V low precision signed integers

$${υ}_{b , v}^{ref} ,$$

such that

$${y}_{b , v}^{ref} = {e}^{{ϵ}_{b}} \cdot {υ}_{b , v}^{ref}$$

Using such a compaction strategy, typical FPGA-based embodiments of the invention can record all aspects of a reference record within as little as fifteen 18-bit words, where: V=13 of these 18-bit words record the

$${υ}_{b , v}^{ref}$$

values; one word records the reference distortion

$${D}_{b}^{ref} ,$$

itself compacted using a floating-point approximation; and one word records the 4-bit exponent ∈_{b}, a reference number of discarded magnitude LSBs

$${p}_{b}^{ref}$$

and, perhaps, a reference length value

$${L}_{b}^{ref} ,$$

that is also compacted using a floating-point approximation. The significance of

$${D}_{b}^{ref}$$

is explained in Section 6.4, while that of

$${p}_{b}^{ref} and {L}_{b}^{ref}$$

is explained at the end of Section 6.2.1. Together, these constitute the summary values for code-block b.

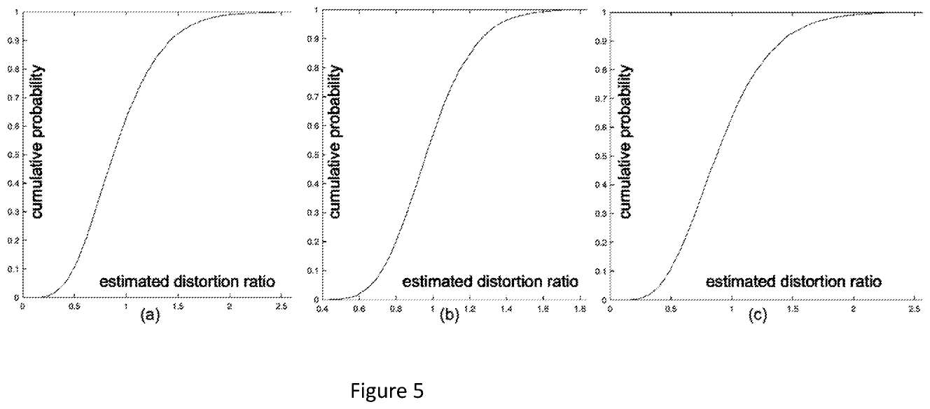

FIG. 5 shows cumulative distribution functions (CDF) for the ratio

$${D}_{b}^{proj} / {D}_{b}^{direct} , where {D}_{b}^{proj}$$

is the value of

$${D}_{b}^{M}$$

estimated using equation (7), while

$${D}_{b}^{direct}$$

is the value of

$${D}_{b}^{M}$$

obtained from equation (4). In each case, the number of code-block samples is 4096 and the number of projections V=13. The CDF's in (a) and (b) arise from temporal difference signals that consist of independent uniformly distributed random noise realisations over [−1,1] and [0,1], respectively. The CDF in (c) arises from shifts of 1 pixel in the horizontal and vertical direction, of reference code-blocks that are generated from sinusoidal patterns with random frequency and orientation.

FIG. 5 shows cumulative distribution functions for the ratio between the

$${D}_{b}^{M}$$

estimate produced by equation (7) and that produced by the direct formulation of equation (4), for a typical case in which V=13 projections are formed. The cumulative distribution functions shown in FIG. 5 involve a code-block with 4096 samples, random commutation of a single adder between V accumulators, as shown in FIG. 4, and three different types of temporal distortion: a) temporal differences

$${x}_{b} [ n ] - {x}_{b}^{ref} [ n ]$$

are drawn from a zero mean uniform random generator; b) temporal differences

$${x}_{b} [ n ] - {x}_{b}^{ref} [ n ]$$

are drawn from a similar random generator whose outputs are unsigned, so that the mean temporal difference is non-zero; and c) block b is obtained by translating a reference block containing a sinusoidal pattern by 1 pixel to the right and downwards, where the sinusoidal pattern's frequency and orientation are themselves drawn from uniformly distributed random variables. This last case simulates structured temporal differences, for which it turns out to be extremely important that the projection vectors are not generated using a repetitive pattern. Evidently, the choice V=13 is sufficient to ensure that the estimated temporal distortions are accurate to within a factor of 2 with quite high probability. Since over-estimation by a factor of 2 is much less likely than under-estimation by a factor of 2, the estimates produced by equation (7) should preferably be attenuated slightly in order to reduce the risk of significantly under-estimating

$${D}_{b}^{M} .$$

While the examples above focus on the more general equation (7), the simpler expression in equation (5), can be preferable for some embodiments. Although that expression over-estimates temporal distortion when

$${μ}_{b}^{diff} \neq 0 ,$$

this only affects low-pass sub-bands. Moreover, over-estimating temporal distortion has the effect of reducing the JSIV transition point for a code-block which makes it more likely that a JSIV encoder will include the code-block's bit-stream within the codestream, rather than relying upon the decoder drawing from a cached version of the code-block from an earlier frame. This can be desirable in cases where there is indeed a mean intensity shift over time.

### 6.2 2^{nd} Aspect: Pre-Estimation of JSIV Transition and PCRD-Opt Truncation Points

The original JSIV framework for optimised dissemination of video, as described in [1], assumes an embedded block coding strategy, such as the one defined in JPEG 2000 Part-1, where each block b is first subjected to embedded coding, resulting in a large number of candidate truncation points t, and then truncated in an optimal manner, using the classic PCRD-opt approach, but taking into account the availability of a reference block with quantization distortion

$${D}_{b}^{ref}$$

and temporal distortion

$${D}_{b}^{M} .$$

In this context, the block's JSIV hull can be determined directly from the embedded bit-stream lengths

$${L}_{b}^{( t )} ,$$

as well as distortion estimates

$${D}_{b}^{( t )} ,$$

that are reported for each coding pass by the embedded block coding algorithm.

This second aspect of the invention shows how it is possible to pre-determine important aspects of the way in which the PCRD-opt rate control procedure will behave, at least approximately, without first performing the embedded block coding process. A key feature of this aspect of the invention is the determination of an approximate JSIV transition point [symbol] ≈t̅_̅{̅b̅}̅. A second feature of this aspect of the invention is the combination of [symbol] with a set of length estimates

$${\tilde{L}}_{b}^{( t )} \approx {L}_{b}^{( t )} ,$$

to form an estimate of the truncation point

$${t}_{b}^{opt}$$

that the PCRD-opt algorithm would be likely to return, for a given set of constraints on the overall encoded length, all without first performing the embedded block coding process. This results in several benefits, as follows:
1. It is possible to identify code-blocks b, for which [symbol] is sufficiently large (due to small

$${D}_{b}^{M} )$$

that the PCRD-opt rate control decision would be to send an empty bit-stream for the block; these blocks need not be coded at all, saving significant computational effort.
2. For other code-blocks, the existence of an estimate for the truncation point

$${t}_{b}^{opt}$$

that the PCRD-opt algorithm would be likely to return allows the set of coding passes performed by the block encoding algorithm to be constrained ahead of time, which also saves computational effort; this is particularly valuable for block coding algorithms that are not fully embedded, such as the HT block coding algorithm defined in JPEG 2000 Part-15.
3. In the extreme case, the estimated

$${t}_{b}^{opt}$$

formed using these methods can be used to determine the quantization parameters for a completely non-embedded block coding algorithm, producing a single bit-stream that cannot be effectively truncated, so that the PCRD-opt algorithm is not actually used, even though

$${t}_{b}^{opt}$$

is obtained by modeling the behaviour of the PCRD-opt algorithm on an embedded block bit-stream.

### 6.2.1 Pre-Estimation of the JSIV Transition Point as a Number of Discarded Magnitude LSBs

To explain the methods used to estimate the JSIV transition point, we make several observations, as follows.

A first observation is that the JSIV transition point t̅_̅{̅b̅}̅, if it exists, necessarily lies on the boundary of the INTRA hull, so long as

$${\overline{D}}_{b}^{( 0 )} < {D}_{b}^{( 0 )} ;$$

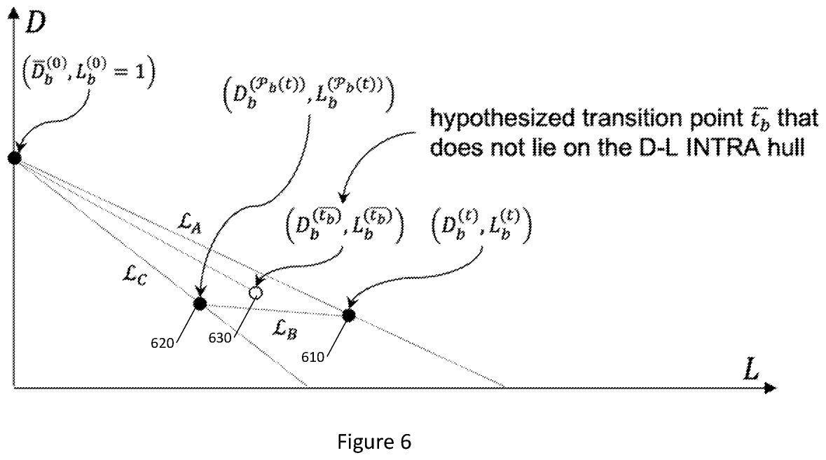

this is demonstrated conclusively by FIG. 6, as explained in the caption. That is, t̅_̅{̅b̅}̅ is one of the truncation points t that could be a rate-distortion optimising outcome from the PCRD-opt algorithm if there were no reference code-block. Moreover, all truncation points t≥t̅_̅{̅b̅}̅ then lie on the boundary of the JSIV hull if and only if they also lie on the boundary of the INTRA hull. To see this, let t be the first point on the INTRA hull beyond t̅_̅{̅b̅}̅. Then S̅_{b} can be no smaller than

$${S}_{b}^{( t )} ;$$

if it were, the JSIV transition point should be t rather than t̅_̅{̅b̅}̅. Thus, points t and t̅_̅{̅b̅}̅= [symbol] _{b}(t) both lie on the boundary of the INTRA hull and it then follows that all INTRA hull boundary points t>t̅_̅{̅b̅}̅ necessarily remain on the JSIV hull.

FIG. 6 is an illustration of the fact that the JSIV transition point t̅_̅{̅b̅}̅ must lie on the D-L INTRA hull if

$${\overline{D}}_{b}^{( 0 )} < {D}_{b}^{( 0 )} ,$$

by assuming otherwise and showing a contradiction. Here, t 610 and [symbol] (t) 620 are consecutive points on the INTRA hull, joined by line segment [symbol] _{B}, such that

$$0 < {L}_{b}^{( {𝒫}_{b} ( t ) )} < {L}_{b}^{( \overline{{t}_{b}} )} < {L}_{b}^{( t )} .$$

Since t̅_̅{̅b̅}̅ 630 is the JSIV transition point, it must lie on the JSIV hull and hence below line segment [symbol] _{A}. However, if t̅_̅{̅b̅}̅ does not itself lie on the INTRA hull, it must be on or above line segment [symbol] _{B}, whose existence follows from the fact that

$${\overline{D}}_{b}^{( 0 )} < {D}_{b}^{( 0 )} .$$

Hence t̅_̅{̅b̅}̅ 630 must also lie above line segment [symbol] _{C}, which implies that t̅_̅{̅b̅}̅ cannot lie on the JSIV hull after all. This geometric illustration can readily be converted into a formal mathematical proof if required.

This observation means that the JSIV hull can be readily derived from the INTRA hull, whose D-L slopes

$${S}_{b}^{( t )}$$

are given by (1). In particular,

$$\overline{{t}_{b}} = min \{ t \vert {S}_{b}^{( t )} > 0 and \frac{{D}_{b}^{M} + ( {D}_{b}^{ref} - {D}_{b}^{( t )} )}{{L}_{b}^{( t )}} > {S}_{b}^{( {𝒩}_{b} ( t ) )} \} , \qquad ( 8 )$$

where the minima here are taken over all INTRA hull boundary points t, and [symbol] (t) denotes the next truncation point beyond t on the INTRA hull, if there is one;

$${S}_{b}^{( {𝒩}_{b} ( t ) )}$$

is taken as 0 if t is the last truncation point on the INTRA hull.

In the special case where

$${\overline{D}}_{b}^{( 0 )} > {D}_{b}^{( 0 )} ,$$

it is possible but extremely unlikely that the observation here does not hold, but in this case it is convenient to simply adopt equation (8) as the definition of the JSIV transition point, so that t̅_̅{̅b̅}̅ is then the first non-empty truncation point on the INTRA hull. In any event, all subsequent points on the INTRA hull certainly lie also on the JSIV hull.

A second observation is that D-L slopes

$${S}_{b}^{( t )}$$

on the INTRA hull can be approximated based on the corresponding quantization step size. To this end, it is convenient to restrict our attention to truncation points of the form

$$t = {P}_{b} - p ,$$

where p is the number of discarded least significant magnitude bits and P_{b} is any convenient upper bound on the number of magnitude bit-planes that are not entirely empty (i.e., not all zero), so that t=0 corresponds to an empty code-block, where all samples are quantized to 0, while t=P_{b} corresponds to the highest possible reconstruction quality, in which all quantized magnitude bit-planes are retained. Write Δ_{b} for the quantization step size associated with the sub-band to which code-block b belongs. Then the effective quantization step size associated with truncation point t is 2^{p}Δ_{b}=2^{P}^{_{b}}^{-t}Δ_{b}.

For each sample that is significant (i.e., non-zero) when p+1 magnitude bit-planes are discarded, the expected increase in coded length between truncation point t−1=P_{b}−(p+1) and t=P_{b}−p is approximately 1 bit, while the expected decrease in reconstructed image distortion is

$$δ {D}_{b}^{( {P}_{b} - p - 1 )} - δ {D}_{b}^{( {P}_{b} - p )} \approx {2}^{2 p} \times \frac{{G}_{b} {Δ}_{b}^{2}}{4} = {2}^{2 p} \times \frac{{B}_{b}}{8}$$

In this expression, G_{b} is the so-called energy gain factor (squared Euclidean norm) of the transform synthesis basis functions for the sub-band to which code-block b belongs, and the reconstructed distortion measure is total squared error. Alternatively, G_{b} can be arranged to incorporate visual weighting factors, so that the distortion measure is visually weighted squared error, as explained also in Section 6.1. What matters here is that

$${B}_{b} = 2 {G}_{b} {Δ}_{b}^{2} \qquad ( 9 )$$

is a constant. For samples that are insignificant (i.e., zero) when p+1 magnitude bit-planes are discarded, but become significant for the first time when only p bit-planes are discarded, the associated increase in coded length is usually much larger than 1 bit, while the reduction in distortion is also much larger than 2^{2p}B_{b}, especially in the case where deadzone quantization is employed, as it is in the case of JPEG 2000 Part-1. For all other samples, neither the coded length nor the distortion is impacted by the transition from p+1 to p discarded magnitude bit-planes.

Both the total change in distortion and the total change in coded length over the code-block, associated with a change in p, are hard to approximate well, since the number of non-zero samples at a given value of p is strongly data dependent; however, with coded length expressed in bytes, the D-L slope can be well approximated by

$${S}_{b}^{( {P}_{b} - p )} = \frac{{D}_{b}^{{P}_{b} - ( p + 1 )} - {D}_{b}^{{P}_{b} - p}}{{L}_{b}^{{P}_{b} - p} - {L}_{b}^{{P}_{b} - ( p + 1 )}} \approx \frac{{2}^{2 p} \times \frac{{B}_{b}}{8}}{\frac{1}{8}} = {2}^{2 p} {B}_{b}$$

Combining this approximation with equation (8), allows us to estimate the JSIV transition point as

$$\tilde{{t}_{b}} = min \{ t \vert {D}_{b}^{M} + ( {D}_{b}^{ref} - {D}_{b}^{( t )} ) > {2}^{2 ( {P}_{b} - ( t + 1 ) )} {L}_{b}^{( t )} {B}_{b} \} , \qquad ( 10 )$$

where we have used [symbol] (t)=t+1.

It is still difficult to use the above expression to estimate the JSIV transition point directly, because both

$${D}_{b}^{( t )} and {L}_{b}^{( t )}$$

are strongly data dependent, as mentioned above. However, this is where we make our third observation, that the most important JSIV transition points to estimate accurately are those that are not very different from the truncation point

$${t}_{b}^{ref}$$

that was selected for the reference code-block when it was encoded in frame

$${k}_{b}^{ref} .$$

Although the true JSIV transition point t̅_̅{̅b̅}̅ could be much larger than

$${t}_{b}^{ref} ,$$

for a practical JSIV-based video encoder it is sufficient to restrict our attention to estimates [symbol] that are no larger than

$${t}_{b}^{ref} + 1.$$

Limiting our attention to truncation at bit-plane boundaries, this means that it is sufficient to constrain the coarsest bit-plane boundary from which the PCRD-opt algorithm can consider sending a non-empty contribution for code-block b to nothing finer than the next finer bit-plane boundary beyond that associated with the reference code-block. This is sufficient to allow each successive video frame to improve the quality of the code-block until such improvement can no longer be sustained given the prevailing constraints on communication bandwidth and hence overall coded length. From the opposite perspective, although the true JSIV transition point t̅_̅{̅b̅}̅ could be much smaller than

$${t}_{b}^{ref} ,$$

if the PCRD-opt algorithm does indeed choose to send a non-empty bit-stream for code-block b, with a truncation point

$${t}_{b}^{opt}$$

that is much smaller than

$${t}_{b}^{ref} ,$$

this will entail a very significant drop in video quality between the reference frame

$${k}_{b}^{ref}$$

and k_{cur}. For high quality encoded video, we do not expect large drops in quality over time to be required.

This third observation suggests that the difficult to estimate terms

$${D}_{b}^{( t )} and {L}_{b}^{( t )}$$

from equation (10) can be simply replaced by

$${D}_{b}^{ref} and {L}_{b}^{ref} ,$$

respectively, being the distortion and length associated with the reference code-block's truncation point

$${t}_{b}^{ref} ,$$

leading to the following estimate for the JSIV transition point

$$\text{?} = min \{ {t}_{b}^{ref} + 1 , min \{ t \vert {D}_{b}^{M} > {2}^{2 ( {P}_{b} - t - 1 )} {L}_{b}^{ref} {B}_{b} \} \} ,$$

which is the same as

$$\text{?} = min \{ {t}_{b}^{ref} + 1 , max \{ t \vert {2}^{2 ( {P}_{b} - t )} {L}_{b}^{ref} {B}_{b} \geq {D}_{b}^{M} \} \} .$$

Equivalently, [symbol] =P_{b}− [symbol] corresponds to discarding [symbol] least significant bit-planes, where

$$\begin{matrix}METHOD - 1 & \\ \tilde{{p}_{b}} = max \{ {p}_{b}^{ref} - 1 , min \{ p \vert {2}^{2 p} {L}_{b}^{ref} {B}_{b} \geq {D}_{b}^{M} \} \} & ( 11 )\end{matrix}$$

and

$${p}_{b}^{ref}$$

is the number of least significant bit-planes that were discarded in the reference code-block.

This first estimation method is very simple, considering that B_{b} and

$${L}_{b}^{ref}$$

both have known values. However, it is likely to over-estimate the JSIV transition point for larger temporal distortions, which can create problems if the video quality does indeed need to drop significantly between the reference and current frames. This is because the method effectively uses a constant estimate of the JSIV transition slope S̅_{b} as

$${D}_{b}^{M} / {L}_{b}^{ref} .$$

### When

$$\overline{{t}_{b}} < {t}_{b}^{ref} , {D}_{b}^{( \overline{{t}_{b}} )}$$

can be expected to be larger than

$${D}_{b}^{ref} and {L}_{b}^{( \overline{{t}_{b}} )}$$

smaller than

$${L}_{b}^{ref} ,$$

so that the actual distortion reduction and length increment associated with transition point t̅_̅{̅b̅}̅ are both smaller than

$${D}_{b}^{M} and {L}_{b}^{ref} ,$$

respectively. Over-estimating the distortion change results in more conservative outcomes regarding the estimated transition point [symbol] , which is not a concern in practice; however, over-estimating the length increment can result in excessive values of [symbol] that might prevent the PCRD-opt algorithm from reducing the video quality gracefully. In the extreme case, where

$${D}_{b}^{M} = {D}_{b}^{( 0 )}$$

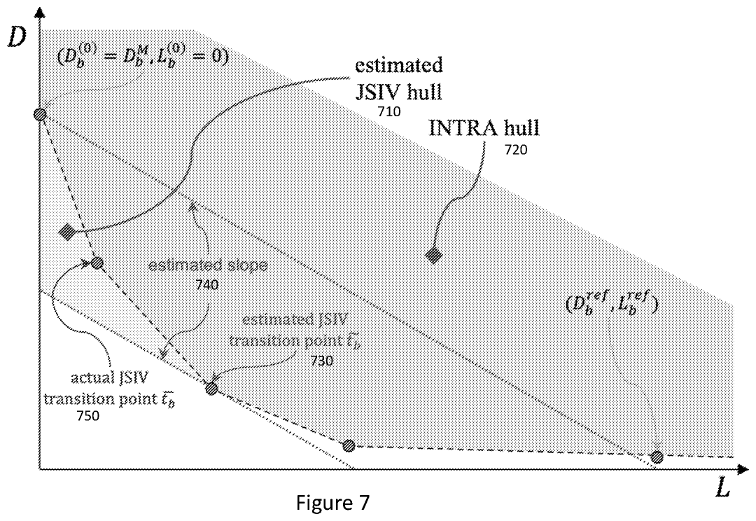

such that the JSIV transition point should be the first non-zero-length truncation point on the INTRA hull, this first estimation method is very likely to over-estimate the transition point, as demonstrated in FIG. 7.

FIG. 7 illustrates over-estimation of the JSIV transition point 750, using the method of equation (11), when

$${D}_{b}^{M}$$

is very large; in this example,

$${D}_{b}^{M} = {D}_{b}^{( 0 )} ,$$

so that the reference code-block has no value for temporal prediction and the JSIV 710 and INTRA 720 hulls should be the same, but the method of equation (11) estimates a later transition point 730.

To address this difficulty, a preferred method for estimating the JSIV transition point makes use of estimates

$${\tilde{L}}_{b}^{( t )}$$

of the coded lengths

$${L}_{b}^{( t )}$$

associated with each truncation point. Again, it is convenient to restrict our attention to truncation points that correspond to whole bit-plane boundaries, so that t=P_{b}−p, where p is the number of discarded least significant bit-planes associated with truncation point t. The estimated length

$${\tilde{L}}_{b}^{( t )}$$

is then conveniently expressed in terms of p rather than t as:

$${\tilde{L}}_{b}^{( t )} = {L}_{b , p}$$

As we shall see, the length estimates L_{b,p} are needed anyway, in order to come up with an estimate of the truncation point

$${t}_{b}^{opt}$$

that can be expected from the PCRD-opt algorithm.

A good choice for this purpose is the length estimation method described in [5], identified herein as the “CPLEX method.” (The CPLEX method is also a core element of the Kakadu software tools for JPEG 2000, as found at https://www.kakadusoftware.com.) This is a low complexity method for providing conservative (typically somewhat larger than actual) estimates L_{b,p} for the number of bytes associated with a “Cleanup pass” from the HT block coding algorithm defined in JPEG 2000 Part-15. In fact, the notation L_{b,p} is deliberately borrowed directly from [5]. The HT block coding algorithm performs a Cleanup pass for each p that may be of interest to the PCRD-opt algorithm, where HT Cleanup bit-streams are not themselves embedded. However, the information contained within the HT Cleanup bit-stream at bit-plane p is identical to the information contained within the first part of the embedded bit-stream produced by the block coding algorithm of JPEG 2000 Part-1, for all coding passes up to and including the Cleanup pass at bit-plane p. Since the HT block coding algorithm is known to be slightly less efficient than the fully embedded block coding algorithm of JPEG 2000 Part-1, the CPLEX method also produces useful conservative estimates L_{b,p} for the coded lengths associated with truncating those block bit-streams at the same magnitude bit-plane p.

Using the CPLEX method, or any other method for deducing coded lengths or at least estimated lengths L_{b,p}, preferred embodiments of the invention estimate the JSIV transition point by using these L_{b,p} values together with the approximation

$${D}_{b}^{( t )} \approx {D}_{b}^{ref} ,$$

so that equation (10) becomes

$$\begin{matrix}METHOD - 2 & \\ \text{?} = max \{ {p}_{b}^{ref} - 1 , max \{ p \vert {D}_{b}^{M} > {2}^{2 ( p - 1 )} {L}_{b , p} {B}_{b} \} \} . & ( 12 )\end{matrix}$$

As explained above, the approximation

$${D}_{b}^{( t )} \approx {D}_{b}^{ref}$$

can over-estimate the distortion change associated with the true JSIV transition point, in the important case when quality must decrease from frame to frame, which results in more conservative outcomes regarding the estimated transition point. For some embodiments, it can be desirable to combine methods 1 and 2 above to produce even more conservative outcomes. Specifically, the goal is simply to take the smaller of the two estimates for [symbol] , which is equivalent to constraining the length estimates L_{b,p} used in the second method to be no larger than

$${L}_{b}^{ref} .$$

### That is,

$$\begin{matrix}METHOD - 3 & \\ \text{?} = max \{ {p}_{b}^{ref} - 1 , max \{ p \vert {D}_{b}^{M} > {2}^{2 ( p - 1 )} min \{ {L}_{b , p} , {L}_{b}^{ref} \} \cdot {B}_{b} \} \} . & ( 13 )\end{matrix}$$

Note that the first and third methods require the reference block quantities

$${L}_{b}^{ref} and {p}_{b}^{ref}$$

to be preserved as 2 of the summary values within the reference record for block b, while the second method needs only

$${p}_{b}^{ref}$$

to be preserved. Of course, all methods rely upon the temporal distortion values

$${D}_{b}^{M} ,$$

which preferred embodiments estimate using the methods of the first aspect of the invention. As explained in Section 6.1, this requires the preservation of V projections per code-block, the storage cost for which usually dominates that of preserving

$${L}_{b}^{ref} and {p}_{b}^{ref}$$

values.

### 6.2.2 Pre-Estimation of PCRD-Opt Outcome as a Number

$${\tilde{p}}_{b}^{opt}$$

### of Discarded Magnitude LSBs

The PCRD-opt algorithm, that is widely employed with JPEG 2000, relies upon knowledge of the coded lengths

$${L}_{b}^{( t )}$$

and distortion contributions

$${D}_{b}^{( t )}$$

associated with each candidate truncation point, to determine an optimal set of truncation points

$${t}_{b}^{opt} ,$$

using equations (1) and (2). In the JSIV case, the D-L slopes in equation (2) come from the JSIV hull, which differs from the original INTRA hull only in that the first non-empty candidate truncation point is the JSIV transition point t̅_̅{̅b̅}̅, having D-L slope S̅_{b} given by equation (3).

It is generally advantageous to have prior knowledge of the truncation points

$${t}_{b}^{opt}$$

that are likely to be selected by the PCRD-opt algorithm, before actually performing the block encoding process. At the very least, this prior knowledge allows an embedded block coding algorithm to terminate early, performing only sufficient coding passes to be sure that

$${t}_{b}^{opt}$$

is reached. This is even more advantageous when the HT block coding algorithm of JPEG 2000 Part-15 (also known as High Throughput JPEG 2000) is employed, as explained in [5]. The algorithm in [5], identified herein as the “CPLEX algorithm”, estimates the

$${t}_{b}^{opt}$$

truncation points based on the observation that an approximately optimal global solution to the rate control problem involves a deterministic relationship between all of the truncation points, which can be written as

$${t}_{b}^{opt} \approx {\tilde{t}}_{b}^{opt} = {P}_{b} - {\tilde{p}}_{b}^{opt} , where {\tilde{p}}_{b}^{opt} = {p}_{b} ( Q ) \qquad ( 14 )$$

Here Q is a global quality parameter (the QP value from [5]) and p_{b}(Q) is a fixed function of Q that depends only upon the quantization, visual weighting and transform basis functions associated with the sub-band to which code-block b belongs. In the preferred embodiments described in [5], Q is an integer parameter that is adjusted in quarter bit-plane steps, so that an increase of 4 in Q results in an increase of 1 in the number of discarded bit-planes p_{b}(Q). Essentially, the function p_{b}(Q) consists only in: a) a fixed scaling factor, to account for the granularity with which quality parameter Q is expressed; b) a fixed offset, to account for the quantization, visual weighting and energy gain factor associated with the sub-band to which code-block b belongs; c) a clipping operation to ensure that p_{b}(Q) lies in the meaningful range from 0 to P_{b}; and d) a rounding operation to ensure that p_{b}(Q) returns an integer number of least significant bit-planes to discard.

Given the mapping in (14), together with a set of conservative length estimates L_{b,p} produced by the CPLEX method, as explained earlier, the CPLEX algorithm assigns

$$Q = min \{ q \vert {\sum }_{b} {L}_{b , {p}_{b} ( q )} \leq {L}_{max} \} , \qquad ( 15 )$$

where Lₘₐₓ is the maximum number of bytes that the PCRD-opt algorithm will be permitted to assign to all block bit-streams.

Since the length estimates L_{b,p} are conservative, this assignment of the quality parameter Q, results in a solution

$${\tilde{p}}_{b}^{opt} = {p}_{b} ( Q ) ,$$

such that when

$${\tilde{p}}_{b}^{opt}$$

least significant magnitude bit-planes are discarded from block b, the total number of bytes in all block bit-streams should actually be significantly less than Lₘₐₓ. This is a desirable property when the CPLEX algorithm is used together with the HT block coding algorithm, since it allows the encoding of code-block b to reliably start from the HT Cleanup pass associated with bit-plane p_{b}(Q), as its coarsest coding pass, producing an additional Z−1 successively finer coding passes; this supplies the final PCRD-opt rate control optimisation stage with a total of Z coding passes and hence Z+1 candidate truncation points. As explained in [5], a typical value for Z is 6, corresponding to 2 HT Cleanup passes, 2 HT SigProp coding passes and 2 HT MagRef coding passes. When used with the fully embedded block coding algorithm of JPEG 2000 Part-1, a similar outcome is produced by stopping the encoding procedure after the first Z+3p_{b}(Q) coding passes, where again Z=6 is usually sufficient to provide adequate optimisation options to the final PCRD-opt rate control stage.

The above description of the CPLEX algorithm ignores the influence of reference code-blocks that is the special feature of a JSIV-based video encoder. Once the JSIV transition points are known, however, it is a simple matter to introduce this feature. In particular, since t̅_̅{̅b̅}̅ is the first non-zero truncation point on the JSIV hull, all code-blocks b for which

$${t}_{b}^{opt} < \overline{{t}_{b}}$$

should be assigned empty bit-streams (length 0), while the lengths of all other code-block bit-streams are estimated in the same manner as described above, since the JSIV hull and INTRA hull are identical beyond the transition point t̅_̅{̅b̅}̅, as explained earlier. This leads to the following quality parameter assignment

$$Q = min \{ q \vert {\sum }_{b ∋ {p}_{b} ( q ) \leq \text{?}} \leq {L}_{b , {p}_{b} ( q )} \leq {L}_{max} \} , \qquad ( 16 )$$

$$with$$

$${\tilde{p}}_{b}^{opt} = \{ \begin{matrix}{p}_{b} ( Q ) & if {p}_{b} ( Q ) \leq \text{?} \\ {P}_{b} & if {p}_{b} ( Q ) > \text{?}\end{matrix} , \qquad ( 17 )$$

where [symbol] is obtained using any of the JSIV transition point estimation methods described in Section 6.2.1.

Equation (16) can be rewritten using a set of modified length estimates

$${L}_{b , p}^{jsiv} = \{ \begin{matrix}{L}_{b , p} & if p \leq \text{?} \\ 0 & if p > \text{?}\end{matrix} \qquad ( 18 )$$

$$so that$$

$$Q = min \{ q \vert {\sum }_{b} {L}_{b , {p}_{b} ( q )}^{jsiv} \leq {L}_{max} \} . \qquad ( 19 )$$

This reveals that the method here for estimating the truncation point

$${\tilde{p}}_{b}^{opt}$$

for each block b is just the original CPLEX algorithm from [5], as in equation (15), with the JSIV conditioned length estimates from equation (18) and the JSIV conditional assignment of equation (17). This observation greatly simplifies the implementation, since it means that the processor or hardware module that selects the quality parameter does not need to have specific knowledge of the JSIV transition point or indeed any quantity related to reference blocks or reference records—it just works with a modified set of length estimates.

Equation (17) shows how pre-determination of the JSIV transition point allows the block coding procedure to be entirely skipped for some code-blocks, namely those for which p_{b}(Q)> [symbol] . This is data dependent of course, so that deployments may still need to be capable of encoding all blocks of each frame; however, avoiding the need to actually encode most of the code-blocks still comes with significant benefits, including a reduction in energy consumption.

Since p_{b}(Q) is usually only an estimate of the number of least significant bit-planes that might be discarded by the PCRD-opt rate control, based on length estimates L_{b,p} that are conservative (likely lower than the true lengths), equation (17) may result in the skipping of some code-blocks whose contribution might actually have value during PCRD-opt optimisation. The likelihood of this may be further increased by the fact that [symbol] itself is an estimate, based primarily on the temporal distortion values

$${D}_{b}^{M} ,$$

which can have their own uncertainties, as discussed in Section 6.1. For these reasons, in some embodiments of the invention equation (17) is replaced by

$${\tilde{p}}_{b}^{opt} = \{ \begin{matrix}{p}_{b} ( Q ) & if ( {p}_{b} ( Q ) \leq ( \text{?} + τ ) \\ {P}_{b} & if ( {p}_{b} ( Q ) > ( \text{?} + τ )\end{matrix} ,$$

where τ is a small positive offset, such as τ=1. More generally, the comparison between p_{b}(Q) and [symbol] that is found in these equations may be performed at fractional bit-plane precision by using a version of the p_{b}(Q) function, call it

$${p}_{b}^{′} ( Q ) ,$$

that skips the step in which scaled and offset Q values are rounded to integers. Using this rounding-free function

$${p}_{b}^{′} ( Q ) ,$$

the offset τ can meaningfully take non-integer values and equation (17) is replaced by

$${\tilde{p}}_{b}^{opt} = \{ \begin{matrix}{p}_{b} ( Q ) & if ( {p}_{b}^{′} ( Q ) \leq ( \tilde{{p}_{b}} + τ ) \\ {P}_{b} & if ( {p}_{b}^{′} ( Q ) > ( \tilde{{p}_{b}} + τ )\end{matrix} . \qquad ( 20 )$$

The methods described above can potentially lead to an outcome in which

$${\tilde{p}}_{b}^{opt} = {P}_{b}$$

for all blocks b that are considered in the quality parameter assignment of equation (19); this is a risk particularly when most or all of the blocks have the same estimated JSIV transition point [symbol] which already represents a high encoded quality level with very small (perhaps zero) temporal distortion. To ensure that the encoder can continue to increase the overall encoded video quality in successive video frames when there is very little temporal change, preferred embodiments of the invention reduce the value of Q (this effectively increases quality), if necessary, to ensure that at least one block winds up with

$${\tilde{p}}_{b}^{opt} < {P}_{b} .$$

One way to do this is to pre-determine an upper bound Qₘₐₓ such that

$${Q}_{max} = max \{ q \vert {p}_{b} ( q ) \leq \tilde{{p}_{b}} for at least one block b \} ,$$

replacing equation (19) with

$$Q = min \{ {Q}_{max} , min \{ q \vert {\sum }_{b} {L}_{b , {p}_{b} ( q )}^{j s i v} \leq {L}_{max} \} \} . \qquad ( 21 )$$

As explained in [5], the summation in equation (15), and hence also that in equation (19) and that in equation (21), does not need to include all code-blocks within an entire image or video frame. Instead, preferred embodiments of the invention work with smaller collections of code-blocks, known as “flush-sets,” producing length estimates L_{b,p}, temporal distortion estimates

$${D}_{b}^{M}$$

and hence JSIV transition point estimates [symbol] , for each code-block in a flush-set, after which the length estimates are modified according to equation (18) and then a quality parameter Q is assigned to the flush-set using equation (19) or equation (21), which allows the

$${\tilde{p}}_{b}^{opt}$$

values to be determined for each code-block in the flush-set using (17) or the more general assignment of (20). In this way, each flush-set is assigned a potentially different quality parameter Q, but the encoding of all code-blocks in a flush-set can proceed soon after the corresponding sample values have become available. This approach is highly suitable for low-latency and low-memory video encoding applications.

As mentioned already, preferred embodiments of the invention use the conservative pre-estimation methods outlined above together with the encoding of Z>1 coding passes for each relevant code-block, so that the PCRD-opt rate control stage is presented with sufficient options to make near optimal decisions regarding the actual point to which each code-block bit-stream is truncated. However, embodiments can certainly work well with small values of Z that do not need to be as large as the typical value of 6 mentioned earlier. In the extreme case where Z=1 and the HT block encoding algorithm of JPEG 2000 Part-15 is employed, only a single HT Cleanup pass is produced for each code-block that is not skipped, which provides the PCRD-opt stage only with the option to either include that HT Cleanup pass in the final codestream or to discard it. While this is not recommended, it exposes the potential to use the methods of this invention with any non-embedded block coding technique. All that is required of the encoding technology, in order to usefully deploy the methods of this invention, is the ability to vary the encoded quality (i.e., the effective level of quantization) from block to block, based on the outcome of the pre-estimation methods described herein. Although the term “block” is used throughout the description of this invention, there is also no specific need to restrict the invention's application to the processing of rectangularly shaped regions of samples within a sub-band or the original frame.

### 6.2.3 Code-Block Pre-Classification and Hard Versus Soft Quality Modulation

Equation (17) and its generalisation in (20) naturally lead to a pre-classification \tilde{Θ}_{b} of each code-block b as either “useful to encode” (\tilde{Θ}_{b}=1) or “not worth encoding” (\tilde{Θ}_{b}=0), where

$${\tilde{Θ}}_{b} = \{ \begin{matrix}1 & if {p}_{b}^{′} ( Q ) \leq ( \text{?} + τ ) \\ 0 & if {p}_{b}^{′} ( Q ) > ( \text{?} + τ )\end{matrix} , \qquad ( 22 )$$

following the more general expression in equation (20). The classification \tilde{Θ}_{b} can be understood as modulating the encoded quality in an extreme fashion, such that code-blocks for which \tilde{Θ}_{b}=1 are encoded to a relatively high precision, such that at most p_{b}(Q) least significant magnitude bit-planes are discarded, while code-blocks for which \tilde{Θ}_{b}=0 have all of their magnitude bit-planes discarded. The term “hard quality modulation” is used here for this approach.

Hard quality modulation is important for use with a “basic JSIV decoder” which interprets any non-empty bit-stream for a code-block as implying that it should be decoded and used in place of any existing reference code-block, becoming the new reference for subsequent video frames. This basic JSIV decoder policy is essentially the one assumed in the original development of the JSIV framework in [1].

In some cases, however, a more sophisticated JSIV decoder may be employed, which explicitly compares the quality and compatibility of an existing reference block with a new non-empty code-block bit-stream in the current frame. Such a decoder, known here as an “advanced JSIV decoder,” is able to determine whether or not a non-empty code-block in the current frame is superior to a reference block, and thus also whether it should become the reference for future frames.

If the encoder is aware the video stream will be decoded by an advanced JSIV decoder, it can be helpful to use a less extreme quality modulation scheme, where code-blocks for which \tilde{Θ}_{b}=0 can still be encoded, but at a significantly lower quality compared to those for which \tilde{Θ}_{b}=1. The term “soft quality modulation” is used here for such an approach.

One benefit of soft quality modulation is that a decoder which starts decoding from an arbitrary point in the video stream can at least obtain a reduced quality representation of every video frame, as opposed to starting with no information at all for the low temporal distortion code-blocks for which \tilde{Θ}_{b}=1. Also, JSIV-unaware decoders that do not attempt to exploit reference code-blocks at all can still reconstruct a usable video sequence, albeit at a reduced quality. Another benefit of soft quality modulation is that an advanced JSIV decoder can decode both the low quality version of code-block b that it receives when \tilde{Θ}_{b}=0 and the higher quality reference that it has from frame

$${k}_{b}^{ref} ,$$

and potentially identify sub-regions within the code-block where the reference might not be compatible with the current frame k_{cur}, using the lower quality up-to-date data in those regions where the reference is not compatible, while using the higher quality reference data everywhere else.

In embodiments of the invention with the soft quality modulation feature that explicitly target advanced JSIV decoders, equation (22) is used first to pre-classify a code-block and then the estimated truncation point is formed according to

$${\tilde{p}}_{b}^{opt} = {\tilde{Θ}}_{b} = \{ \begin{matrix}{p}_{b} ( Q ) & if {\tilde{Θ}}_{b} = 1 \\ {p}_{b} ( Q ) + D & if {\tilde{Θ}}_{b} = 0\end{matrix} , \qquad ( 23 )$$

where D>0 is a quality reduction factor that amounts to a number of additional least significant magnitude bit-planes to discard when \tilde{Θ}_{b}=0. Typical values for D range from 1 to 3. In these embodiments, the determination of quality parameter Q still follows the original CPLEX algorithm [5] with modified lengths, as embodied by equation (19) or equation (21), but the modified lengths themselves are formed taking into account the fact that code-blocks for which \tilde{Θ}_{b}=0 will not generally have empty bit-streams. Specifically, equation (18) is replaced by

$${L}_{b , p}^{j s i v} = \{ \begin{matrix}{L}_{b , p} & if p \leq \tilde{{p}_{b}} \\ {L}_{b , {p}_{b} ( q ) + D} & if p > \tilde{{p}_{b}}\end{matrix} \qquad ( 24 )$$

### 6.3 3^{rd} Aspect: Memory and Complexity Reduction Through Code-Block Grouping

This aspect of the invention provides methods for reducing storage requirements within a JSIV-based video encoder, by extending the projection-based estimation of temporal distortion from individual code-blocks to groups of co-located code-blocks. In various embodiments, a group g consists of co-located code-blocks from the HL, LH and HH sub-bands at the same decomposition level of a discrete wavelet transform and/or co-located code-blocks from different image components, such as colour planes.

In embodiments that group blocks, a single set of V projection values y_{g,v} is formed for each group g, rather than for individual code-blocks, using projection vectors e_{g,v} that are extended over all code-blocks of the group. In these embodiments, all code-blocks within a group g use reference code-blocks from the same reference frame

$${k}_{ℊ}^{ref} ,$$

and the projection values for the current and reference frame are used to estimate a single temporal distortion

$${D}_{ℊ}^{M}$$

for the entire group.

The methods described in Section 6.1 are applied in essentially the same way to groups as they are to individual code-blocks. Preferred embodiments of the invention perform the projection on quantized samples, where the quantization step sizes Δ_{b}, associated with the sub-band to which block b belongs, are selected to be inversely proportional to \sqrt{G_{b}}, so that the distortion scaling factor φ_{b}=G_{b}Δ_{b}² is the same for all code-blocks in group g. Writing φ_{g} for this common distortion scaling factor, the complete partial sums formulation of equation (7) becomes

$${D}_{ℊ}^{M} = {ϕ}_{ℊ} \cdot [ \text{} {\sum }_{v = 0}^{V - 1} {( {y}_{ℊ , v} - {y}_{ℊ , v}^{ref} )}^{2} + \frac{( {\sum }_{v = 0}^{V - 1} {( {y}_{ℊ , v} - {y}_{ℊ , v}^{ref} )}^{2} ) ( {A}_{ℊ} - {\sum }_{v = 0}^{V - 1} {μ}^{2} ( {e}_{ℊ , v} ) )}{{A}_{ℊ}^{2}} ] , \qquad ( 25 )$$

where A_{g}=Σ_{b∈g}A_{b} is the total number of samples in all blocks of the group and μ(e_{g,v}) is a count of the number of elements accumulated in each partial sum y_{g,v}. The other expressions in 6.1 can be similarly converted from block-based to group-based temporal distortion estimators.

The group temporal distortion value

$${D}_{ℊ}^{M}$$

being estimated here corresponds to the total squared error (or visually weighted squared error) associated with replacing each block within group g in the current frame k_{cur} with the corresponding samples from the reference frame

$${k}_{ℊ}^{ref} ,$$

As to the pre-estimation methods of Section 6.2, a single JSIV transition point estimate [symbol] is produced for each group, using quantization based models for the D-L slope. To ensure that these models are consistent in all code-blocks of the group, it is again preferable to select quantization step sizes Δ_{b} that are inversely proportional to \sqrt{G_{b}}, so that all code-blocks participating in the group have the same value for

$${B}_{b} = 2 {G}_{b} {Δ}_{b}^{2} .$$

Write B_{g} for this group-wide value and note that B_{g} is equal to twice the distortion scaling factor φ_{g} when distortion estimates are formed from projections of the quantized sample values, as explained above.

The simplest per-block transition point estimation method from (11) is then readily converted to a per-group transition point estimation method as

$$\text{?} = max \{ {p}_{ℊ}^{ref} - 1 , min \{ p \vert {2}^{2 p} {L}_{ℊ}^{ref} {B}_{ℊ} \geq {D}_{ℊ}^{M} \} \} . \qquad ( 26 )$$

Here, [symbol] expresses the JSIV transition point for all blocks b in group g in terms of the number of least significant magnitude bit-planes that would be discarded at the transition point; that is, [symbol] for all blocks b in group

$$ℊ \cdot {p}_{ℊ}^{ref}$$

is the smallest number of discarded least significant bit-planes over all reference code-blocks associated with group g, while

$${L}_{ℊ}^{ref}$$

is the total number of bytes found in the bit-streams of all reference code-blocks associated with group g.

The other per-block transition point estimation methods described in Section 6.2.1 are similarly converted to per-group transition point estimation methods. For example, equation (12) becomes

$$\text{?} = max \{ {p}_{ℊ}^{ref} - 1 , max \{ p \vert {D}_{ℊ}^{M} > {2}^{2 ( p - 1 )} {L}_{ℊ , p} {B}_{ℊ} \} \} , \qquad ( 27 )$$

where length estimates L_{g,p} are obtained by accumulating the individual code-block length estimates L_{b,p} for each block b in group g.

So long as

$${G}_{b} {Δ}_{b}^{2}$$

has the same value (B_{g}/2) for all blocks b in group g, the methods described in Sections 6.2.2 and 6.2.3 can be used without any modification in embodiments of the invention that group code-blocks. This is because the function p_{b}(Q) that maps quality factor Q to a number of discarded least significant magnitude bit-planes for block b is the same for all blocks b in the group, and the same is true for the non-rounded version of the function

$${p}_{b}^{′} ( Q ) .$$

Writing p_{g}(Q) and

$${p}_{ℊ}^{′} ( Q )$$

for these group-wide mapping functions, and noting that all blocks in the group have the same JSIV transition threshold, so that [symbol] , the pre-classification of equation (22) also produces the same result \tilde{Θ}_{b}=\tilde{Θ}_{g} for all blocks b in group g, where

$${\tilde{Θ}}_{ℊ} = \{ \begin{matrix}1 & if {p}_{ℊ}^{′} ( Q ) \leq ( \text{?} + τ ) \\ 0 & if {p}_{ℊ}^{′} ( Q ) > ( \text{?} + τ )\end{matrix} . \qquad ( 28 )$$

As a result, \tilde{Θ}_{g}=0 means that none of the blocks in group g need to be encoded, or else an additional D least significant magnitude bit-planes are discarded from all blocks of the group, depending on whether hard or soft quality modulation is being employed.

### 6.4 4^{th} Aspect: Determination of Distortion-Length Slopes

Unlike the first three aspects of the invention, this fourth aspect is concerned with the utilisation of information produced by the block encoding procedure. This information includes the actual coded length values

$${L}_{b}^{( t )}$$

and actual (or approximate) distortion values

$${D}_{b}^{( t )}$$

for each available truncation point t, as opposed to estimates formed prior to actual block encoding.

### 6.4.1 Embodiments that Process Blocks Independently

A first task is to determine the actual JSIV transition slope S̅_{b}, using equations (3) and (8), noting that this requires the reference block distortion

$${D}_{b}^{ref}$$

or a similar quantity to be preserved amongst the summary values within the reference record for block b.

Existing implementations of both the JPEG 2000 Part-1 block encoder and the HT block coding algorithm defined in JPEG 2000 Part-15 typically do not calculate or estimate the absolute distortion values

$${D}_{b}^{( t )} ;$$

instead, it is somewhat simpler to approximate the distortion reduction

$$Δ {D}_{b}^{( t )} = {D}_{b}^{( t - 1 )} - {D}_{b}^{( t )} \qquad ( 29 )$$

for each candidate truncation point t>0, since this is all that is required to compute D-L slopes

$${S}_{b}^{( t )}$$

on the block's INTRA hull, for use with the PCRD-opt rate control algorithm. To use such existing block encoding implementations directly within the JSIV framework is not completely trivial, since equations (3) and (8) need to add temporal distortion estimate

$${D}_{b}^{M}$$

to the quantity

$${D}_{b}^{ref} - {D}_{b}^{( t )} .$$

Absolute quantization distortion

$${D}_{b}^{( t )}$$

can be rewritten in terms of the code-block energy

$${E}_{b} = {D}_{b}^{( 0 )} ,$$

together with the available distortion reduction values, as

$${D}_{b}^{( t )} = {E}_{b} - {\sum }_{u - 1}^{t} Δ {D}_{b}^{( u )} \qquad ( 30 )$$

Moreover, E_{b} can be estimated from the V projection values y_{b,v} for code-block b as

$${E}_{b} \approx {A}_{b} \cdot {ϕ}_{b} \cdot [ \frac{{\sum }_{v = 0}^{V - 1} {y}_{b , v}^{2}}{{\sum }_{v = 0}^{V - 1} {‖ {e}_{b , v} ‖}^{2}} - \frac{{( {\sum }_{v = 0}^{V - 1} {y}_{b , v} )}^{2} {\sum }_{v = 0}^{V - 1} {μ}^{2} ( {e}_{b , v} )}{{( {\sum }_{v = 0}^{V - 1} μ ( {e}_{b , v} ) )}^{2} {\sum }_{v = 0}^{V - 1} {‖ {e}_{b , v} ‖}^{2}} + \frac{{( {\sum }_{v = 0}^{V - 1} {y}_{b , v} )}^{2}}{{( {\sum }_{v = 0}^{V - 1} μ ( {e}_{b , v} ) )}^{2}} ] , \qquad ( 31 )$$

which is obtained simply by replace

$${y}_{b , v}^{ref}$$

with 0 in equation (6). In the special case of projections that are formed as complete partial sums, this simplifies to

$${E}_{b} \approx {ϕ}_{b} \cdot [ {\sum }_{v = 0}^{V - 1} {y}_{b , v}^{2} + \frac{{( {\sum }_{v = 0}^{V - 1} {y}_{b , v} )}^{2} ( Ab - {\sum }_{v = 0}^{V - 1} {μ}^{2} ( {e}_{b , v} ) )}{{A}_{b}^{2}} ] . \qquad ( 32 )$$

Moreover, for blocks from high-pass sub-bands, this can be simplified to

$${E}_{b} \approx {ϕ}_{b} \cdot {\sum }_{v = 0}^{V - 1} {y}_{b , v}^{2} . \qquad ( 33 )$$

Embodiments of the invention can use these expressions to derive absolute distortions from incremental distortion reductions with relative ease, so that the absolute distortion

$${D}_{b}^{ref}$$

can also be recorded as one of the summary values within the reference record for block b whenever it needs to be updated.

The PCRD-opt rate control algorithm itself assigns truncation points

$${t}_{b}^{opt} ( λ )$$

based on a global distortion-length slope threshold λ, which is iteratively modified until the assigned truncation points result in an encoded video stream that satisfies all relevant bit-rate constraints. Specifically, for each candidate slope threshold λ, a code-block classification Θ_{b}(λ) is found from

$${Θ}_{b} ( λ ) = \{ \begin{matrix}1 & if {\overline{S}}_{b} > λ \\ 0 & if {\overline{S}}_{b} \leq λ\end{matrix} . \qquad ( 34 )$$

If Θ_{b}(λ)=1, equation (2) is used directly to assign truncation point

$${t}_{b}^{opt} ( λ ) .$$

Otherwise (Θ_{b}(λ)=0), embodiments of the invention that use hard quality modulation assign

$${t}_{b}^{opt} ( λ ) = 0$$

(empty block bit-stream), while embodiments that use soft quality modulation use the following “soft” version of equation (2) to assign

$${t}_{b}^{opt} ( λ ) .$$

$$[ Soft PCRD - opt assignment ] {t}_{b}^{opt} ( λ ) = max \{ t \vert {S}_{b}^{( t )} > {2}^{2 D} λ \} .$$

The scaling factor of 2^{2D} in equation (35) effectively increases the D-L slope

$${S}_{b}^{( t )}$$

associated with truncation point

$${t}_{b}^{opt} ( λ )$$

for blocks whose quality is to be “soft modulated” (Θ_{b}(λ)=0), which is substantially equivalent to increasing the number of discarded least significant magnitude bit-planes in those blocks by D. This is consistent with the way in which the integer parameter D is used for soft quality modulation during the pre-estimation steps—see equation Error! Reference source not found.

Once the iterative search for a suitable slope threshold is over, call it λ°, the finalized classification label Θ_{b}(λ°) determines whether or not the reference frame

$${k}_{b}^{ref}$$

for block b should be updated to k_{cur}, for use in encoding the next video frame. Specifically,

$${k}_{b}^{ref}$$

is updated to k_{cur} if and only if Θ_{b}(λ°)=1. Embodiments of the invention do not actually need to record the reference frame index

$${k}_{b}^{ref}$$

itself, since it is not used directly in any method of the invention, but they do need to update the block's reference record whenever Θ_{b}(λ°)=1, updating the V projection values

$${y}_{b , v}^{ref} ,$$

the reference distortion

$${D}_{b}^{ref} ,$$

reference discarded least significant bit-plane count

$${p}_{b}^{ref}$$

and (perhaps) the reference coded length

$${L}_{b}^{ref} ,$$

as explained earlier.

The truncation point

$${t}_{b}^{opt} ( {λ}^{∘} )$$

determines what portion of the bit-stream for code-block b eventually contributes to the encoded video stream.

Some embodiments of the invention embed marker codes within the encoded video stream that explicitly identify blocks for which Θ_{b}(λ°)=1. This can easily be achieved within code-streams conforming to the JPEG 2000 specification (Part-1 or Part-15) without altering the behaviour of a basic JSIV decoder. Such marker codes allow a sufficiently aware client to determine whether the encoding policy is using reference blocks or not, so that the behaviour of the client can also correctly decode content that has not been encoded using the JSIV framework. An additional benefit of such an approach is that clients that use the marker codes can be used equally well with encoders that employ either hard quality modulation or soft quality modulation.

### 6.4.2 Embodiments that Group Code-Blocks

In embodiments that group blocks, so that a single temporal distortion estimate

$${D}_{g}^{M}$$

is found for each group rather than each individual block, there can be only one JSIV transition slope S̅_{g} for each group, such that all blocks in the group share the same transition slope S̅_{b}=S̅_{g}. This is necessary to ensure that all blocks in the group can have the same reference frame

$${k}_{g}^{ref} ,$$

so that only a single reference record is required per group, whose contents are updated whenever

$${k}_{g}^{ref}$$

changes. In these embodiments a single group-wide reference distortion

$${D}_{g}^{ref}$$

needs to be preserved in the group's reference record, which is the sum of the

$${D}_{b}^{ref}$$

values for all blocks b in the group g.

Preferred embodiments of the invention determine S̅_{g} from a group D-L characteristic formed by interleaving contributions from each block in the group in decreasing order of their INTRA slopes

$${S}_{b}^{( t )} .$$

Specifically, let i enumerate the interleaved block INTRA hull points and write

$${i}_{b}^{( t )}$$

for the enumeration index associated with truncation point t on the block b INTRA hull, as it appears in the interleaved order. Also write

$${t}_{b}^{( i )}$$

for the largest INTRA hull point for block b whose interleaved index is no larger than i; that is,

$${t}_{b}^{( i )} = max \{ t \vert {S}_{b}^{( t )} > 0 and {i}_{b}^{( t )} \leq i \} . \qquad ( 36 )$$

Then the group D-L characteristic has distortion, length and slope values

$${D}_{g}^{( i )} = {\sum }_{b ∈ g} {D}_{b}^{( {t}_{b}^{( i )} )} , {L}_{g}^{( i )} = {\sum }_{b ∈ g} max \{ {L}_{b}^{( {t}_{b}^{( t )} )} , {L}_{zero} \} and \\ {S}_{g}^{( i )} = {min}_{b} {S}_{b}^{( {t}_{b}^{( t )} )} ; \qquad ( 37 )$$

these slopes

$${S}_{g}^{( i )}$$

are monotonically non-increasing with i. In the above expression for

$${L}_{g}^{( i )} ,$$

L_{zero} is the minimum non-zero number of bytes that can be assigned to a valid block bit-stream whose decoded sample values will be all 0; for the JPEG 2000 Part-1 block coding algorithm, L_{zero}=1, while for the HT block coding algorithm defined in JPEG 2000 Part-15, L_{zero}=2. This L_{zero} term is important only when targeting a “basic JSIV decoder,” which updates its notion of the reference code-block only when it encounters a non-empty code-block bit-stream and may be unaware of block grouping within the server. When targeting an “advanced JSIV decoder,” L_{zero} can be 0.

Using the group D-L characteristic, the group JSIV transition slope is obtained by converting equation (3) into

$${\overline{S}}_{g} = \frac{{\overline{D}}_{g}^{( 0 )} - {D}_{g}^{( \overline{{ι}_{g}} )}}{{L}_{g}^{( \overline{{ι}_{g}} )}} = \frac{{D}_{g}^{M} + {D}_{g}^{ref} - {D}_{g}^{( \overline{{ι}_{g}} )}}{{L}_{g}^{( \overline{{ι}_{g}} )}} , \qquad ( 38 )$$

while the group JSIV transition point ι̅_̅{̅g̅}̅ is obtained by converting equation (8) into

$$\overline{{ι}_{g}} = min \{ i \vert \frac{{D}_{g}^{M} + ( {D}_{g}^{r e f} - {D}_{g}^{( i )} )}{{L}_{g}^{( i )}} > {S}_{g}^{( i + 1 )} \} . \qquad ( 39 )$$

Note that all indices i correspond to

$$( {D}_{g}^{( i )} , {L}_{g}^{( i )} )$$

values that lie on the convex hull of the group D-L characteristic.

For each candidate slope threshold λ, a code-block classification Θ_{b}(λ) is found from equation (34), just as before, with S̅_{b}=S̅_{g}. This means that all code-blocks in group g have the same classification

$${Θ}_{b} ( λ ) = {Θ}_{g} ( λ ) = \{ \begin{matrix}1 & if {\overline{S}}_{g} > λ \\ 0 & if {\overline{S}}_{g} \leq λ\end{matrix} . \qquad ( 40 )$$

If Θ_{b}(λ)=1, equation (2) is used directly to assign truncation point

$${t}_{b}^{opt} ( λ ) .$$

Otherwise (Θ_{b}(λ)=0), embodiments of the invention that use hard quality modulation assign

$${t}_{b}^{opt} ( λ ) = 0$$

(empty block bit-stream), while embodiments that use soft quality modulation use equation (35) to assign

$${t}_{b}^{opt} ( λ ) .$$

Once the iterative search for a suitable slope threshold is over, yielding λ° as the final slope threshold, the finalized classification label Θ_{g}(λ°) determines whether or not the reference frame

$${k}_{g}^{ref}$$

for group g should be updated to k_{cur}, for use in encoding the next video frame. Specifically,

$${k}_{g}^{ref}$$

is updated to k_{cur} if and only if Θ_{g}(λ°)=1. Again, embodiments of the invention do not actually need to record the reference frame index

$${k}_{g}^{ref}$$

itself, but they do need to update the group's reference record.

The truncation point

$${t}_{b}^{opt} ( λ° )$$

determines what portion of the bit-stream for code-block b eventually contributes to the encoded video stream, with the one caveat that if Θ_{b}(λ°)=1 then at least L_{zero} bytes need to be emitted for each code-block b in the group, even if

$${t}_{b}^{opt} ( λ° ) = 0 ,$$

as explained above.

### 6.5 Aspect 5: Periodic Refresh

As explained in Section 2, JSIV-based video encoding is just a special case of the generic JSIV client-server framework described in [1], where the server is integrated with the encoder and there is only one client, which receives and decodes the encoded video stream. In practice, however, it is desirable to allow multiple decoders to join the encoded video service at arbitrary points in time, so that newly joined decoders will not generally have access to all of the reference blocks assumed by the encoder. In cases where temporal distortion is very low, these reference blocks might not be replenished by high quality encoded representations for a very long time. As noted in Section 2, this difficulty is addressed by existing conditional replenishment schemes, and video codecs in general, by introducing some sort of periodic refresh policy, which ensures that all coded elements (code-blocks here) are encoded without the aid of any temporal reference from time to time. This section describes suitable methods by which a JSIV-based video encoder can do exactly this.

### 6.5.1 Embodiments that Process Blocks Independently

Preferred embodiments of the invention periodically re-initialize the reference record associated with each code-block. After such re-initialization, the block appears to have no reference in the next video frame. The temporal distortion

$${D}_{b}^{M}$$

for a block whose reference record has been newly initialised or re-initialised should be the same as

$${D}_{b}^{( 0 )} ,$$

so that the block's JSIV hull and INTRA hull are identical.

The term “periodic” here is not intended to imply that the encoder's refresh policy must re-initialize reference records on a fixed schedule. All that is required is that each code-block has an opportunity to be assigned a non-empty bit-stream within the encoded video stream from time to time. One way to achieve this is to re-initialize a block's reference record if its finalized classification label Θ_{b}(λ°) has been 0 for the most recent K consecutive video frames. Then the parameter K determines how long a decoder may need to wait after joining the video stream at an arbitrary point, before its decoded video quality can reach the quality of a decoder that started decoding from the very first encoded frame.

Preferred embodiments of the invention employ a periodic refresh policy that limits the number of code-blocks whose reference records can be re-initialized in any given frame and also distributes those blocks in such a way that the periodic refresh policy does not excessively interfere with the image quality that can be achieved by the PCRD-opt rate control stage. In particular, if PCRD-opt rate control is exercised on small flush-sets, as discussed in Section 6.2.2, then the periodic refresh policy preferably limits the number of reference records that can be re-initialised within any flush-set—a limit of at most one per flush-set is appropriate for many applications.

Interestingly, embodiments of the invention that implement a periodic refresh policy, along with the soft quality modulation scheme described in Section 6.2.3, can get away with grossly under-estimating the temporal distortion values

$${D}_{b}^{M} ,$$

while still producing a useful encoded video stream. In fact, such embodiments can even work with

$${D}_{b}^{M} = 0$$

for all b, producing an encoded video stream in which code-block quality is periodically modulated without any regard for the actual temporal distortion. Sophisticated decoders that can decode both the version of a code-block that is received in the current frame and the corresponding reference code-block, analysing both to determine which regions are compatible with the reference frame and which are not, can potentially exploit such quality modulated video streams to reconstruct high quality reconstructed video. Notwithstanding this, such decoders can be expected to reconstruct even higher quality video when the encoder produces and exploits meaningful temporal distortion estimates

$${D}_{b}^{M}$$

according to the methods of this invention.

### 6.5.2 Embodiments that Group Code-Blocks

For embodiments of the invention that group blocks, reference records are associated with groups rather than blocks, so periodic refresh can be implemented in the same manner described above, by periodically re-initializing the reference record for each group. Again, one way to achieve this is to re-initialize a group's reference record if its finalized classification label Θ_{b}(λ°) has been 0 for the most recent K consecutive video frames. Again, if PCRD-opt rate control is exercised on small flush-sets, as discussed in Section 6.2.2, then the periodic refresh policy preferably limits the number of reference records that can be re-initialised within any flush-set—e.g., to at most one.

However, since groups may consist of many code-blocks, periodic refresh policies that operate at the group level can significantly interfere with the image quality that is achievable by the PCRD-opt rate control stage, especially within small flush-sets that might not have many groups. To avoid this, embodiments of the invention that group blocks can adopt a periodic refresh policy that refreshes code-blocks rather than whole groups. In some embodiments, at most one code-block b within any given group g is refreshed in any given frame. In this case, the group's reference record is not re-initialised at all, but code-block b is treated as though its JSIV transition slope S̅_{b} were infinite during the PCRD-opt rate control stage, unlike all other blocks in the group that adopt the common transition slope S̅_{g}. Equivalently, block b's classification outcome Θ_{b}(λ)=1, while all other blocks in the group use Θ_{g}(λ) which could be 0 or 1. In these embodiments, group g's reference record continues to reflect the state of the group's most recent reference frame, even though some of its code-blocks may have subsequently been refreshed, but this is not expected to adversely impact the decoded video quality.

It is to be understood that, if any prior art publication is referred to herein, such reference does not constitute an admission that the publication forms a part of the common general knowledge in the art, in Australia or any other country.

In the claims which follow and in the preceding description of the invention, except where the context requires otherwise due to express language or necessary implication, the word “comprise” or variations such as “comprises” or “comprising” is used in an inclusive sense, i.e. to specify the presence of the stated features but not to preclude the presence or addition of further features in various embodiments of the invention.

### 7 BIBLIOGRAPHY

[1] A. Naman and D. Taubman, “JPEG 2000-based scalable interactive video (JSIV),” IEEE Transactions on Image Processing, vol. 20, no. 5, pp. 1435-1449, 2011.
[2] D. Taubman and M. Marcellin, JPEG 2000: Image compression fundamentals, standards and practice, Boston: Kluwer Academic Publishers, 2002.
[3] D. Taubman and R. Prandolini, “Architecture, philosophy and performance of JPIP: internet protocol standard for JPEG 2000,” in International Symposium on Visual Communication and Image Processing, 2003.
[4] M. Shand and D. e. Yvelines, “Frame buffer compression for video processing devices”. US Patent 2011/0310974 A1, 22 Dec. 2011.
[5] D. Taubman, “Method and apparatus for complexity control in High Throughput JPEG 2000 (HTJ2K) encoding”. Patent WO/2021/077178, April 2021.

Throughout the specification references to JPEG 2000 or JPEG 2000 standards can be taken to refer to the standards documents:
ITU-T T.800|ISO/IEC 15444-1: Information technology—JPEG 2000 image coding system—Part 1: Core coding system
ITU-T T.814|ISO/IEC 15444-15: Information technology—JPEG 2000 image coding system—Part 15: High-Throughput JPEG 2000

1. A method for encoding a sequence of video frames, each having been transformed to produce a plurality of sample blocks, the method involving:
a. Recording, in a reference record, information for a reference block that was encoded in a previous frame of the video sequence, the reference record recording at least: a set of summary values for the reference block, a number of summary values in the set being smaller than a number of samples in the block, and information related to the quality of the encoded reference block;
b. estimating temporal distortion between the reference block and a corresponding block of the current frame, identified here as the current block, based on a set of summary values for the current block and the corresponding set of summary values for the reference block that are stored within the reference record;
c. determining a lower bound on an encoded quality level to which the current block should be encoded in order for the block's encoded representation to be considered for inclusion in the encoded video stream, based on the estimated temporal distortion together with information related to the quality of the reference block, this bound being identified here as a JSIV transition point;
d. encoding the sample values of the current block to one or more encoded quality levels;
e. selecting the encoded quality level to which each block in a plurality of sample blocks in the current frame is encoded, taking into account the JSIV transition point, so that the overall encoded length of the plurality of blocks does not exceed a specified length constraint; and
f. updating the reference record with information derived from the current block, in the event that the coded representation of the current block that is included in the encoded video stream reaches at least the lower bound identified by the JSIV transition point.

2. The method of claim 1, wherein the summary values are obtained using linear projection onto a set of projection vectors, wherein the set of summary values for the current block and the corresponding set of summary values of its reference block, are obtained using the same set of projection vectors.

3. The method of claim 2, wherein coefficients of each projection vector are derived using a pseudo-random number generator, and wherein coefficients of each projection vector are either 1 or 0, the total number of 1's in the complete set of projection vectors for a block is equal to the number of samples in the block and the projection vectors are mutually orthogonal.

4. The method of claim 2, wherein coefficients of each projection vector are either 1 or 0, the total number of 1's in the complete set of projection vectors for a block is equal to the number of samples in the block and the projection vectors are mutually orthogonal.

5. The method of claim 2, wherein coefficients of each projection vector are derived using a pseudo-random number generator, and wherein the coefficients of each projection vector are either 1 or −1.

6. The method of claim 2, wherein the temporal distortion estimate is derived from the sum of squared differences between the summary values for the current block and the summary values for the reference block.

7. The method of claim 1, further comprising a pre-estimation step that estimates the JSIV transition point without first encoding the current block, by using the estimated temporal distortion, together with information related to the encoded quality level of the reference block.

8. (canceled)

9. The method of claim 7, wherein:
the pre-estimation step also estimates a coded length associated with each one of a plurality of potential encoded quality levels for the current block; the pre-estimation step uses the estimated JSIV transition point and estimated coded length values, for the current block and any other block within a plurality of sample blocks in the current frame whose overall encoded length should not exceed the specified length constraint, without first encoding all of said sample blocks, to estimate an encoded quality level and associated coded length for each of said blocks such that the overall encoded length will not exceed the specified length constraint; and
wherein the current block is subsequently encoded to the estimated encoded quality level determined by the pre-estimation step.

10. (canceled)

11. The method of claim 7, wherein:
the pre-estimation step also estimates a coded length associated with each one of a plurality of potential encoded quality levels for the current block;
the pre-estimation step uses the estimated JSIV transition point and estimated coded length values, for the current block and any other block within a plurality of sample blocks in the current frame whose overall encoded length should not exceed the specified length constraint, without first encoding all of said sample blocks, to estimate an encoded quality level and associated coded length for each of said blocks such that the overall encoded length will not exceed the specified length constraint; and the current block is subsequently encoded to each one of a plurality of encoded quality levels, where the range of said plurality of encoded quality levels is based on the estimated quality levels determined by the pre-estimation step.

12. The method of claim 11, further comprising a rate distortion optimising step which selects a final encoded quality level for the encoded representation of the current block from the plurality of encoded quality levels to which it has been encoded, using information regarding the encoded lengths and associated impact on image distortion determined during the block encoding process, together with the estimated block temporal distortion value.

13. The method of claim 1, where a plurality of blocks are collected into groups, such that each current block in a current group has an associated reference block that was encoded in the same previous frame, these reference blocks forming a reference group, wherein: a) one reference record is maintained for each group, rather than each individual block; b) one temporal distortion value is estimated for each group, rather than each block, based on a set of summary values for the group and a corresponding set of summary values for the reference group that are stored in the reference record, a number of summary values in the set for the group being smaller than a number of samples within all blocks of the group; c) a JSIV transition point is determined for the group, establishing a lower bound on the encoded quality level for all blocks in the group; d) the encoded quality level to which each block in a plurality of sample blocks in the current frame is encoded is selected, taking into account the group JSIV transition point, so that the overall encoded length of the plurality of blocks does not exceed a specified length constraint; and e) the reference record for the group is updated in the event that the coded representation of the blocks from the group that is included in the encoded video stream reaches at least the lower bound identified by the group's JSIV transition point.

14. The method of claim 13, wherein the summary values are obtained using linear projection onto a set of projection vectors, wherein the set of summary values for a group and the corresponding set of summary values for its reference group are obtained using the same set of projection vectors.

15. The method of claim 14, wherein the projection vectors are formed using a method, wherein the summary values are obtained using linear projection onto a set of projection vectors, wherein the set of summary values for the current block and the corresponding set of summary values of its reference block, are obtained using the same set of projection vectors, wherein coefficients of each projection vector are derived using a pseudo-random number generator, and wherein coefficients of each projection vector are either 1 or 0, the total number of 1's in the complete set of projection vectors for a block is equal to the number of samples in the block and the projection vectors are mutually orthogonal.

16. The method of claim 14, wherein the temporal distortion estimate is derived from the sum of squared differences between the summary values for the current group and the summary values for the reference group.

17. The method of claim 13, further comprising a pre-estimation step that estimates the JSIV transition point for the current group without first encoding the blocks of the group, by using the group's estimated temporal distortion, together with information related to the encoded quality level of the reference blocks in the reference group.

18. (canceled)

19. The method of claim 18, wherein:
the pre-estimation step also estimates the coded length associated with a plurality of potential qualities for all blocks in the current group;
the pre-estimation step uses the estimated JSIV transition point and estimated coded length values, for the current group and any other group containing blocks within the plurality of blocks of the current frame, whose overall encoded length should not exceed the specified length constraint, without first encoding all of said sample blocks, to estimate an encoded quality level and associated coded length for each of said blocks such that the overall encoded length will not exceed the specified length constraint; and
wherein the blocks of the current group are subsequently encoded to the estimated quality level determined by the pre-estimation step.

20. (canceled)

21. The method of claim 17 wherein:
the pre-estimation step also estimates the coded length associated with a plurality of potential qualities for all blocks in the current group;
the pre-estimation step uses the estimated JSIV transition point and estimated coded length values, for the current group and any other group containing blocks within the plurality of blocks of the current frame, whose overall encoded length should not exceed the specified length constraint, without first encoding all of said sample blocks, to estimate an encoded quality level and associated coded length for each of said blocks such that the overall encoded length will not exceed the specified length constraint; and
wherein the blocks of the current group are subsequently encoded to each one of a plurality of encoded quality levels, where the range of said plurality of encoded quality levels is based on the estimated encoded quality level determined by the pre-estimation step.

22. The method of claim 21, further comprising a rate distortion optimising step which selects the final quality for the encoded representation of each block of the current group from the plurality of encoded quality levels to which it has been encoded, using information regarding the encoded lengths and associated impact on image distortion determined during the block encoding process, together with the estimated group temporal distortion value.

23. The method of claim 1, wherein the quality of the encoded representation of a block within the encoded video stream is increased to a level commensurate with that of blocks having no reference block, if more than a specified number of frames have elapsed since the coded representation of the block that was included in the encoded video stream reached at least the lower bound identified in each of those frames by the corresponding JSIV transition point.

24. A system for encoding a sequence of video frames, each having been transformed to produce a plurality of sample blocks, the system comprising: memory configured to store:
a. a reference record recording information for a reference block that was encoded in a previous frame of the video sequence, the reference record recording at least: a set of summary values for the reference block, a number of summary values in the set being smaller than a number of samples in the block, and information related to the quality of the encoded reference block;
processing logic configured to:
b. estimate temporal distortion between the reference block and a corresponding block of the current frame, identified here as the current block, based on a set of summary values for the current block and the corresponding set of summary values for the reference block that are stored within the reference record;
c. determine a lower bound on an encoded quality level to which the current block should be encoded in order for the block's encoded representation to be considered for inclusion in the encoded video stream, using the estimated temporal distortion together with information related to the quality of the reference block, recovered from the reference record, this bound being identified here as the JSIV transition point;
d. encode the sample values of the current block to one or more encoded quality levels;
e. select the encoded quality level to which each block in a plurality of sample blocks in the current frame is encoded, taking into account a JSIV transition point, so that the overall encoded length of the plurality of blocks does not exceed a specified length constraint; and
f. update the reference record with information derived from the current block, in the event that the coded representation of the current block that is included in the encoded video stream reaches at least the lower bound identified by the JSIV transition point.
